(19) United States
(12) Patent Application Publication
(10) Pub. No.: US 2002/0114747 A1
(43) Pub. Date: Aug. 22, 2002

(54) Fuel processing system and apparatus therefor

(76) Inventors: Kevin Marchand, Burnaby (CA); David S. Watkins, Coquitlam (CA)

Correspondence Address: Robert W. Fieseler, McAndrews, Held & Malloy, Ltd., 34th Floor, 500 West Madison Street, Chicago, IL, 60661, US

(21) Appl. No.: 09/752,792

(22) Filed: Dec. 28, 2000

(51) Int. Cl. B01J 7/00; B01J 8/02

(52) U.S. Cl. 422/198; 423/652; 422/211; 422/194; 422/190; 422/196; 422/197; 422/220; 48/127.9; 48/76

(57) ABSTRACT

Improved fuel processing systems convert a hydrocarbon fuel into a reformate stream comprising hydrogen. Improved steam reformers and fuel processing systems employ steam reforming catalyst compositions that are oxygen-tolerant and/or sulfur-tolerant. Improved fuel processing systems employ shift reactors comprise shift catalyst compositions that are oxygen-tolerant and self-reducing. Improved fuel processing systems also comprise a preoxidizer or first-stage selective oxidizer, shift reactor, and selective oxidizer connected in series. An improved integrated reactor comprises a metal oxide bed and shift catalyst bed, and fuel processing systems comprising the improved integrated reactor.

### FIELD OF THE INVENTION

The present invention relates to fuel processing systems for converting a hydrocarbon fuel into a reformate stream comprising hydrogen, methods of operation of such fuel processing systems, and components therefor. In particular, the present invention relates to fuel processing systems and apparatus employing steam reforming catalyst compositions that are oxygen-tolerant, sulfur-tolerant, or both, and/or shift catalyst compositions that are oxygen-tolerant and self-reducing.

### BACKGROUND OF THE INVENTION

The search for alternative power sources has focused attention on the use of electrochemical fuel cells to generate electrical power. Unlike conventional fossil fuel power sources, fuel cells are capable of generating electrical power from a fuel stream and an oxidant stream without producing substantial amounts of undesirable by-products, such as sulfides, nitrogen oxides and carbon monoxide. However, the commercial viability of fuel cell electric power generation systems will benefit from the ability to efficiently and cleanly convert conventional hydrocarbon fuel sources, such as, for example, gasoline, diesel, natural gas, ethane, butane, light distillates, dimethyl ether, methanol, ethanol, propane, naphtha, kerosene, and combinations thereof, to a hydrogen-rich gas stream with increased reliability and decreased cost. The conversion of such fuel sources to a hydrogen-rich gas stream is also important for other industrial processes, as well.

Fuel processing systems, such as for use in fuel cell electric power generation systems, typically employ several processing steps.

Primary conversion of the raw hydrocarbon fuel to hydrogen is typically achieved by reforming the fuel in a reformer. Suitable reformers include steam reformers, partial oxidation reformers, and autothermal reformers.

Steam reformers convert hydrocarbon fuel and steam in a steam reforming catalyst bed (typically nickel-, copper- or noble metal-based catalyst), producing hydrogen, carbon dioxide (CO₂), and carbon monoxide (CO). For example, the following principal reactions occur in the steam reforming of methane (and natural gas):

$$\begin{matrix}{CH}_{4} + {H}_{2} O ⇌ CO + 3 {H}_{2} \\ CO + {H}_{2} O ⇌ {CO}_{2} + {H}_{2} \\ {CH}_{4} + 2 {H}_{2} O ⇌ {CO}_{2} + 4 {H}_{2}\end{matrix} \qquad ( I )$$

The overall reaction (I) is highly endothermic, and is normally carried out at elevated catalyst temperatures in the range of about 500° C. to about 800° C. Such elevated temperatures are typically generated by the heat of combustion from a burner incorporated in the steam reformer.

Autothermal reforming is an approach that combines catalytic partial oxidation and steam reforming. Partial oxidation employs substoichiometric combustion to achieve the temperatures necessary to reform the hydrocarbon fuel. Fuel, oxidant (oxygen or air, for example) and steam are reacted to form hydrogen, CO₂ and CO. An advantage of autothermal reforming technology is that the exothermic combustion reactions are directly used to drive the endothermic reforming reaction (I).

A water gas shift reactor (“shift reactor”) is often employed to reduce the CO concentration in the reformate stream produced by the reformer in order to reduce poisoning of the catalyst employed in the fuel cells and to produce additional hydrogen fuel. In the shift reactor, CO is combined with water in the presence of a catalyst to yield carbon dioxide and hydrogen according to the following reaction:

CO+H₂O [symbol] CO₂+H₂ (II)

Even after a combination of reformer/shift reactor processing, the product gas mixture will have minor amounts of CO present at about 1% or less of the total product mixture. In many instances, the reformate stream exiting the shift reactor is passed through a selective oxidizer, to further reduce the concentration of CO present in the stream.

In typical fuel processing systems employing steam reformers having nickel-based catalysts, the reformer is preceded upstream by a device for removing sulfur. For example, a hydrotreating apparatus such as a hydrodesulfurizer (HDS) and an H₂S removal device, such as a ZnO bed, or other reduced base metal absorbent beds, may be employed in order to remove or reduce to extremely low levels any sulfur present in the fuel. Such sulfur removal components are typically required because sulfur is a poison to nickel-based catalysts at normal operating temperatures. Even in fuel processing systems employing autothermal reformers, downstream sulfur removal is typically required because sulfur also poisons other components of the system, such as shift catalysts, selective oxidation catalysts, and/or fuel cell catalysts.

In some applications, such as stationary fuel cell electric power generation systems, for example, the fuel may include peak shave gas. Peak shave gas comprises natural gas with propane and air added. The oxygen present in the fuel can adversely affect the performance of the HDS. In addition, nickel-based steam reforming catalysts are not oxygen tolerant, so the presence of residual oxygen in the fuel is also problematic. In such applications, a noble metal catalyst bed is typically placed upstream of the HDS, and the oxygen-containing fuel is combined with some recycled reformate to combust the oxygen before the fuel is supplied to the HDS. This approach, however, adds significant complexity and cost to the overall system and reduces system efficiency.

### SUMMARY OF THE INVENTION

An improved steam reformer converts a fuel into a reformate stream. The present reformer comprises:

(a) a closed vessel;

(b) a catalyst bed disposed within the vessel, the catalyst bed comprising a catalyst composition that is at least oxygen-tolerant;

(c) a reactant inlet for directing a reactant stream to the catalyst bed, the reactant comprising fuel; and

(d) an oxidant inlet for directing an oxidant to the catalyst bed.

The catalyst composition may comprise a noble metal compound. The catalyst composition may be oxygen-tolerant and sulfur-tolerant. The present steam reformer may have a burner integrated into the steam reformer vessel, or the burner may be separately housed. The present steam reformer may be of any suitable construction, such as shell-and-tube or plate-and-frame, for example.

In one embodiment, a fuel processing system converts a fuel into a reformate stream, wherein the fuel processing system comprises the present steam reformer.

In another embodiment, the present fuel processing system comprises:

(a) a steam reformer having at least one catalyst bed disposed therein, the at least one catalyst bed comprising a catalyst composition that is at least oxygen-tolerant; and

(b) an oxidant supply adapted to supply an oxidant to the catalyst bed.

The embodiment may further comprise a shift reactor and/or a selective oxidizer located downstream of the steam reformer and fluidly connected thereto. It may also comprise a pressure swing adsorption (PSA) unit located downstream of the steam reformer, in addition to the shift reactor and/or selective oxidizer, or instead of the latter, or both, components.

In another embodiment, the present fuel processing system further comprises:

(c) a preoxidizer located downstream of the steam reformer and fluidly connected thereto;

(d) a shift reactor located downstream of the preoxidizer and fluidly connected thereto, the shift reactor comprising a shift catalyst bed; and

(e) a selective oxidizer located downstream of the shift reactor and fluidly connected thereto.

In yet another embodiment, a first-stage selective oxidizer replaces the foregoing preoxidizer.

In any of the foregoing embodiments, the present fuel processing system may further comprise a downstream hydrogen separation unit comprising at least one hydrogen separation membrane, or a downstream PSA unit. The fuel processing system may also further comprise a sulfur removal apparatus, such as hydrodesulfurizers and metal oxide beds, zeolite absorbent beds, or hot carbonate scrubbers, for example, upstream of the steam reformer. The fuel processing system may also further comprise a fuel cell stack located downstream of the other components for receiving the reformate stream. The fuel cell stack may comprise solid polymer electrolyte fuel cells.

The shift reactor of the present fuel processing system may comprise an oxygen-tolerant, self-reducing shift catalyst composition, in which case the present fuel processing system may further comprise an oxidant supply adapted to supply oxidant to the shift reactor.

An improved method initiates operation of the foregoing embodiments of the present fuel processing system. The method comprises heating at least a portion of the steam reformer catalyst bed to a predetermined ignition temperature and supplying reactants comprising fuel and oxidant to the catalyst bed and catalytically combusting at least a portion of the reactants therein to supply heat thereto. Supply of oxidant to the steam reformer catalyst bed may be interrupted when at least a portion of the catalyst bed at least reaches a predetermined threshold temperature, such as the minimum operating temperature of the bed. The reactants may further comprise steam, and the method may further comprise reforming a portion of the fuel in the steam reformer catalyst bed to produce a reformate stream.

Where the fuel processing system comprises a preoxidizer, as discussed above, the present method may further comprise supplying oxidant and reformate to the preoxidizer and catalytically combusting at least a portion of the reactants therein to produce a heated reformate stream. The heated reformate stream may then be supplied to the downstream shift reactor to heat the shift catalyst bed. The amount of oxidant supplied to the preoxidizer may be controlled so that substantially all of the oxidant is consumed therein. Supply of oxidant to the preoxidizer may be interrupted when at least a portion of the shift catalyst bed at least reaches a predetermined threshold temperature, such as the minimum operating temperature of the shift catalyst bed.

Where the fuel processing system comprises a shift reactor having an oxygen-tolerant, self-reducing shift catalyst composition, the method may further comprise supplying oxidant to the shift catalyst bed to oxidize at least a portion thereof to generate heat. Reformate or an inert gas may also be supplied with the oxidant. Supply of oxidant may also be interrupted when at least a portion of the shift catalyst bed at least reaches a predetermined threshold temperature.

An improved method operates the foregoing embodiments of the present fuel processing system. In the present method, fuel and steam are provided to the steam reformer catalyst bed to reform a portion of the fuel to a reformate stream. Oxidant is also supplied to the catalyst bed and fuel and oxidant are catalytically combusted therein. The supply of oxidant may be adjusted and/or interrupted in response to output requirements of the fuel processing system.

In another embodiment of the present fuel processing system, the steam reformer thereof has at least one catalyst bed comprising a catalyst composition that is at least sulfur-tolerant, and a sulfur removal apparatus located downstream of the steam reformer and fluidly connected thereto. The sulfur removal apparatus may comprise such components as PSA units, metal oxide bed, reduced base metal absorbent beds, and hot carbonate scrubbers, for example.

The fuel processing system may further comprise a hydrogen separation unit downstream of the sulfur removal apparatus. The fuel processing system may also further comprise a shift reactor located downstream of the sulfur removal apparatus and optionally a selective oxidizer downstream of the shift reactor. There may also be a preoxidizer located upstream of the shift reactor, as discussed above. Similarly, a first-stage selective oxidizer may replace the preoxidizer.

The shift reactor of the present fuel processing system may comprise an oxygen-tolerant, self-reducing shift catalyst composition, in which case the embodiment of the present fuel processing system may further comprise an oxidant supply adapted to supply oxidant to the shift reactor.

Where the steam reformer catalyst bed comprises an oxygen-tolerant and sulfur-tolerant catalyst composition, the present fuel processing system may further comprise an oxidant supply adapted to supply an oxidant to the steam reformer catalyst bed.

The fuel processing system may also further comprise a fuel cell stack located downstream of the other components for receiving the reformate stream. The fuel cell stack may comprise solid polymer electrolyte fuel cells.

An improved method operates the foregoing embodiment of the present fuel processing system. The method comprises supplying fuel and steam to the steam reformer catalyst bed and reforming at least a portion of the fuel therein to produce a reformate stream, and supplying the reformate stream to the downstream sulfur removal apparatus to reduce the concentration of hydrogen sulfide in the reformate to below a predetermined threshold concentration. The threshold concentration of hydrogen sulfide may be less than or equal to 1 parts per million (ppm), or less than or equal to 0.5 ppm, for example.

Where the steam reformer catalyst bed comprises a sulfur-tolerant catalyst composition, the method may further comprise transiently increasing the amount of steam supplied to the catalyst bed relative to the amount of fuel supplied thereto. The amount of steam supplied to the catalyst bed may be increased intermittently. The amount of steam supplied to the catalyst bed may be adjusted in response to a measured parameter indicative of decreasing activity of the steam reformer catalyst composition.

Where the steam reformer catalyst bed comprises a sulfur-tolerant catalyst composition, the method may comprise supplying oxidant to the catalyst bed, and catalytically combusting a portion of the fuel therein. The method may further comprise transiently increasing the amount of steam supplied to the catalyst bed relative to the amount of fuel supplied thereto, as discussed in the preceding paragraph.

In another embodiment, the present fuel processing system comprises:

(a) a reformer;

(b) a preoxidizer located downstream of the reformer and fluidly connected thereto, the preoxidizer comprising a combustion catalyst bed;

(c) a shift reactor located downstream of the preoxidizer and fluidly connected thereto, the shift reactor comprising a shift catalyst bed; and

(d) an oxidant supply adapted to supply an oxidant to the preoxidizer.

The embodiment may further comprise a selective oxidizer located downstream of the shift reactor. The fuel processing system may also further comprise a fuel cell stack located downstream of the other components for receiving the reformate stream. The fuel cell stack may comprise solid polymer electrolyte fuel cells.

The preoxidizer may further comprise a heating device for heating the combustion catalyst bed. The shift reactor may comprise an oxygen-tolerant, self-reducing shift catalyst composition, in which case the embodiment of the present fuel processing system may further comprise an oxidant supply adapted to supply oxidant to the shift reactor.

An improved method initiates operation of the foregoing embodiment of the present fuel processing system. The method comprises supplying oxidant and reformate to the preoxidizer and catalytically combusting at least a portion of the reactants therein to produce a heated reformate stream. The heated reformate stream may then be supplied to the downstream shift reactor to heat the shift catalyst bed. The amount of oxidant supplied to the preoxidizer may be controlled so that substantially all of the oxidant is consumed therein. Supply of oxidant to the preoxidizer may be interrupted when at least a portion of the shift catalyst bed at least reaches a predetermined threshold temperature, such as the minimum operating temperature of the shift catalyst bed. The method may further comprise heating at least a portion of the preoxidizer catalyst bed to a predetermined ignition temperature before supplying reformate and oxidant thereto.

Where the fuel processing system comprises a shift reactor having an oxygen-tolerant, self-reducing shift catalyst composition, the method may further comprise supplying oxidant to the shift catalyst bed to oxidize at least a portion thereof to generate heat. Reformate or an inert gas may also be supplied with the oxidant. Supply of oxidant may also be interrupted when at least a portion of the shift catalyst bed at least reaches a predetermined threshold temperature.

Another improved method initiates operation of a fuel processing system comprising a reformer and a shift reactor having a shift catalyst bed comprising an oxygen-tolerant, self-reducing shift catalyst composition. The method is as described in the preceding paragraph.

In another embodiment, the present fuel processing system comprises:

(a) a reformer;

(b) a first selective oxidizer located downstream of the reformer and fluidly connected thereto, the first selective oxidizer comprising a selective oxidation catalyst bed;

(c) a shift reactor located downstream of the first selective oxidizer and fluidly connected thereto, the shift reactor comprising a shift catalyst bed;

(d) a second selective oxidizer located downstream of the shift reactor and fluidly connected thereto; and

(e) at least one oxidant supply adapted to supply an oxidant to the first and second selective oxidizers.

The first selective oxidizer may further comprise a heating device for heating the combustion catalyst bed. The fuel processing system may also further comprise a fuel cell stack located downstream of the other components for receiving the reformate stream. The fuel cell stack may comprise solid polymer electrolyte fuel cells. The shift reactor may comprise an oxygen-tolerant, self-reducing shift catalyst composition, in which case the embodiment of the present fuel processing system may further comprise an oxidant supply adapted to supply oxidant to the shift reactor.

An improved method initiates operation of the foregoing embodiment of the present fuel processing system. The method comprises:

(a) supplying a reformate stream and oxidant to the first selective oxidizer and catalytically oxidizing at least a portion of the carbon monoxide present in the reformate stream to produce a heated reformate stream;

(b) supplying the heated reformate stream to the shift reactor; and

(c) supplying the heated reformate stream from the shift reactor and oxidant to the second selective oxidizer to reduce the concentration of carbon monoxide in reformate stream to below a predetermined threshold concentration.

The method may further comprise heating at least a portion of the selective oxidation catalyst bed of the first selective oxidizer to a predetermined ignition temperature before supplying the reformate stream and oxidant thereto. The threshold concentration of carbon monoxide may be less than or equal to about 10 ppm CO, for example. The method may further comprise supplying the reformate stream from the second selective oxidizer to a fuel cell stack, which may comprise solid polymer electrolyte fuel cells.

An improved integrated reactor, in one embodiment, comprises:

(a) a closed vessel having a reformate inlet and a reformate outlet for receiving and discharging, respectively, a reformate stream, and having a coolant inlet and a coolant outlet for receiving and discharging, respectively, a coolant fluid stream;

(b) a metal oxide bed disposed within the vessel and in fluid communication with the reformate inlet;

(c) a shift catalyst bed disposed within the vessel downstream of the metal oxide bed, the shift catalyst bed in fluid communication with the metal oxide bed and the reformate outlet; and

(d) at least one heat exchange element in fluid communication with the coolant inlet and the coolant outlet, and in thermal communication with the metal oxide bed and the shift catalyst bed, wherein the at least one heat exchange element is fluidly isolated from the metal oxide bed and the shift catalyst bed.

The metal oxide bed may comprise zinc oxide (and this is the case for any metal oxide bed discussed previously). The coolant fluid stream may comprise air, water, or thermal oils, for example.

In another embodiment, the present integrated reactor further comprises a high-temperature shift catalyst bed upstream of the metal oxide bed.

In yet another embodiment, the present integrated reactor further comprises a reduced base metal absorbent bed interposed between the metal oxide bed and the shift catalyst bed. The reduced base metal absorbent bed may comprise a copper-zinc compound.

In a further embodiment, the present integrated reactor further comprises a high-temperature shift catalyst bed upstream of the metal oxide bed, and a reduced base metal absorbent bed interposed between the metal oxide bed and the shift catalyst bed.

In any of the foregoing embodiments, the present integrated reactor may further comprise a chamber disposed within the reactor vessel that is in fluid communication with the reformate inlet and outlet and has the various beds disposed therein. The heat exchange element(s) may comprise at least one passage extending through at least a portion of the chamber. The exterior surface of the chamber may also comprise a heat exchange element.

In any of the foregoing embodiments, the various beds of the present integrated reactor may comprise pelletized or monolith material.

An improved fuel processing system comprises a reformer and the present integrated reactor.

### BRIEF DESCRIPTION OF THE DRAWINGS

FIG. 1 is a schematic illustration of a conventional fuel processing system for use in a fuel cell electric power generation system.

FIGS. 2-6 are schematic illustrations of embodiments of the present fuel processing system and components thereof for use in a fuel cell electric power generation system.

FIG. 7 is a schematic illustration in cross-section of an embodiment of the present integrated metal oxide absorbent bed and shift reactor.

### DETAILED DESCRIPTION OF PREFERRED EMBODIMENT(S)

As described herein and in the appended claims, fuel means gaseous or liquid fuels comprising aliphatic hydrocarbons and oxygenated derivatives thereof, and may further comprise aromatic hydrocarbons and oxygenated derivatives thereof. Oxidant means substantially pure oxygen, or a fluid stream comprising oxygen, such as air or fuel cell cathode exhaust. Reformate means the gas stream comprising hydrogen produced from a fuel by a fuel processing system or component(s) thereof, including but not limited to reformers, shift reactors, selective oxidizers, one or more sulfur removal apparatus, or any combination thereof. Inert gas means an unreactive gas stream comprising nitrogen, helium, or argon, for example.

Reformer means any apparatus suitable for converting a fuel into a reformate stream and includes but is not necessarily limited to steam reformers, partial oxidation reformers, catalytic partial oxidation reformers, autothermal reformers, and plasma reformers. Reformers may be of any suitable construction, such as shell-and-tube or plate-and-frame, for example.

A steam reformer is a reformer comprising a steam reforming catalyst bed and a heat transfer surface for transferring the heat supplied by burner combustion gases to the catalyst bed. The burner may be integrated into the steam reformer vessel, or it may be separately housed. Again, the steam reformer may be of any suitable construction, such as shell-and-tube or plate-and-frame, for example.

“Catalyst bed” comprises the catalyst composition employed in a particular fuel processing component and includes the catalyst bed structure. Suitable catalyst bed structures include particulate catalyst components and monoliths. For example, suitable catalyst bed structures include catalyst components disposed on a pelletized porous support, or disposed on a monolithic porous support, such as ceramic honeycomb or expanded metal foam, for instance. Noble metal compound means a composition comprising noble metals, noble metal alloys, or noble metal oxides. Ignition temperature refers to the minimum temperature at which a catalytic combustion reaction will self-ignite in the presence of a catalyst.

Unless otherwise specified, a shift reactor may have a catalyst bed comprising low-temperature, medium-temperature, or high-temperature shift catalyst compositions, or any combination thereof. For example, a low- or medium-temperature shift catalyst bed may comprise a copper-containing composition such as Cu/Zn oxide shift catalyst, and a high-temperature shift catalyst bed may comprise an iron-containing composition such as Fe/Cr shift catalyst.

As used herein, when two components are fluidly connected to one another, there may be other components in between them, and the other components may effect the fluid connection but not eliminate it altogether.

The present apparatus comprises a fuel processing system and components thereof that employ catalysts in a steam reformer that are oxygen tolerant, sulfur tolerant, or both.

An oxygen-tolerant steam reforming catalyst composition retains a satisfactory degree of activity for the steam reforming reaction when oxygen gas is introduced into the catalyst bed in the presence of fuel. In particular, an oxygen-tolerant steam reforming catalyst composition is not deactivated due to, for example, oxidation of the catalyst. As well, the catalyst composition is not sintered or otherwise permanently deactivated due to the exothermic reaction, and resulting temperature rise, associated with the catalytic combustion of the oxygen with the fuel or the hydrogen produced during reforming.

Similarly, A sulfur-tolerant steam reforming catalyst composition retains a satisfactory degree of activity for the steam reforming reaction when sulfur is present in the fuel during the duty cycle of the reformer.

A satisfactory degree of activity, with respect to an oxygen-tolerant and/or sulfur-tolerant steam reforming catalyst composition may be calculated in several ways. For example, a satisfactory degree of activity may be determined by the extra volume of catalyst required to produce a given reformer output in the presence of oxygen and/or sulfur, as compared to the volume of catalyst required to produce the same reformer output in the absence of oxygen and/or sulfur. Where the volume of extra catalyst required is small enough that the steam reformer is economically practical, for instance, the catalyst composition may have a satisfactory degree of activity. The actual value for a satisfactory degree of activity is, of course, system-dependent, and will vary depending on various factors including but not limited to size and cost of the steam reformer, complexity of the fuel processing system as a whole, expected output of the system, and the level of oxygen and/or sulfur in the catalyst bed. Persons skilled in the art may determine a satisfactory degree of activity for a given steam reformer and fuel processing system.

As described herein with respect to steam reforming catalysts, a catalyst composition that is at least oxygen-tolerant may also be, but is not necessarily, sulfur-tolerant. Similarly, a catalyst composition that is at least sulfur-tolerant may also be, but is not necessarily, oxygen-tolerant.

The present steam reformer may provide for shorter start-up times relative to steam reformers employing nickel and other base metal steam reforming catalysts. The present fuel processing system may also provide for quicker start-up and may be simpler and less costly than conventional fuel processing systems. Improved methods operate the present apparatus.

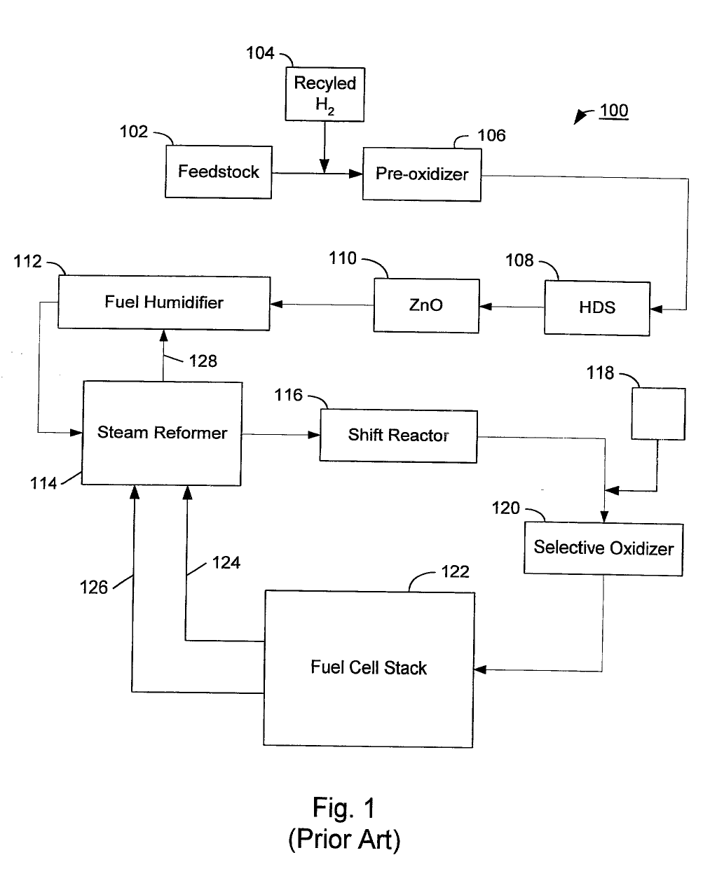

A conventional fuel processing system for use in a fuel cell electric power generation system is illustrated schematically in FIG. 1. Raw fuel is supplied to fuel processing system 100 via supply 102. Fuel is mixed with a small amount of hydrogen-rich gas stream recycled from a hydrogen source 104 and passed through preoxidizer 106 where any oxygen present in the fuel is consumed. If the fuel does not contain oxygen, then preoxidizer 106 need not be employed and without reactants will remain idle.

The mixed fuel/hydrogen stream is then passed through HDS 108 where sulfur in the mixture reacts with hydrogen (from the recycle gas) in the presence of catalyst to form primarily H₂S. The fuel stream exiting HDS 108 is then passed over ZnO bed 110 where the H₂S is removed. As described herein, a ZnO bed is a metal oxide absorbent bed comprising ZnO-based compositions, but which may also comprise other elements as well.

The fuel stream exiting ZnO bed 110 is then directed through humidifier 112 where it is mixed with water and/or steam. The humidified fuel stream exiting humidifier 112 is then introduced into steam reformer 114. The humidified fuel stream reacts with a typically base metal catalyst in the catalyst bed of reformer 114 to produce a hydrogen-rich reformate stream containing CO₂, CO, raw fuel and water vapor.

The reformate stream exiting reformer 114 is then directed to shift reactor 116, where at least a portion of the carbon monoxide in the reformate stream is converted in the shift catalyst bed into carbon dioxide and hydrogen according to equation (II), above. The reformate stream exiting shift reactor 116 is then mixed with oxidant from oxidant supply 118 and directed through selective oxidizer 120. Alternatively, oxidant may be supplied to the inlet of selective oxidizer 120, or directly into the catalyst bed, if desired. In selective oxidizer 120, a substantial amount of the remaining CO in the reformate stream is converted in the presence of oxygen into carbon dioxide within the selective oxidation catalyst bed. Typically, the reformate stream exiting selective oxidizer 120 contains less than about 10 ppm CO.

The reformate stream exiting selective oxidizer 120 is then supplied to fuel cell stack 122. Reformate supplied to the anodes of the fuel cells in stack 122, along with oxidant supplied to the cathodes thereof, generate electric power in stack 122. Anode and cathode exhaust 124 and 126, respectively, are fed to the burner of steam reformer 114 where they are combusted to provide at least a portion of the heat energy for the endothermic steam reforming reactions. Burner exhaust gas 128 is supplied to humidifier 112 to provide the heat energy for substantially vaporizing the water entrained in the fuel stream within humidifier 112.

Note that the fuel processing system of FIG. 1, and the embodiments of the present fuel processing system described below, further comprise compressors and heat exchange elements, as required, for ensuring that each component of the fuel processing system receives the relevant gas stream at an appropriate temperature and pressure. Illustration and discussion of these components have been omitted for the sake of clarity, but it is understood that the fuel processing systems will further include such components as required by overall system design.

As mentioned previously, base metal steam reforming catalysts, such as nickel catalysts, are not sulfur tolerant. Thus, upstream sulfur removal from the fuel is required, optionally including an upstream preoxidizer where the fuel includes peak shave gas, as shown in FIG. 1. Thus, the use of base metal reforming catalysts can add significant complexity and cost to the FPS due to lack of sulfur tolerance.

Peak shave gas also contains nitrogen, due to the presence of added air. Steam reforming nitrogen-containing fuel using nickel catalysts can result in ammonia formation. This can be problematic in fuel cell-related applications, as ammonia gas is potentially damaging to fuel cells. In addition, nickel carbonyl can also be formed in the presence of nickel catalysts, especially during shutdown of the steam reformer. Such compounds are potentially damaging to fuel cells, and are also very toxic, and are to be avoided.

In addition, base metal steam reforming catalysts (and shift reactor catalysts) are not oxygen tolerant, and therefore the catalyst bed must be heated externally, which is a time-consuming process during start-up.

Typical fuel processing systems for fuel cell electric power generation systems can take anywhere from about one to about five hours to start up. (In this application, the term “start up” means to initiate operation.) The components that are typically the slowest to start up are the steam reformer, shift reactors, and selective oxidizers. Slow start-up times can limit the applications for fuel cell electric power generation systems.

Thus, fuel processing systems employing steam reformers with base metal catalysts are less than optimal, particularly for use in fuel cell electric power generation applications. Such fuel processing systems tend to be relatively complex and costly, with undesirably long start-up times.

Autothermal reformers typically employ noble metal catalysts that may be oxygen- and/or sulfur-tolerant. Autothermal reformers operate at higher temperatures, with typical operating temperatures at least about 300° C. higher than steam reformers. At such temperatures, autothermal reformers tend to be more tolerant to sulfur. Organic sulfur that passes through the reformer is converted to H₂S, which simplifies downstream sulfur removal since an HDS unit is not required. Start-up times of autothermal reformers also tend to be shorter due to the heat supplied directly to the catalyst bed by catalytic combustion.

However, fuel processing systems employing autothermal reformers may also be less than optimal. For example, high operating temperatures require the use of high-temperature materials in reformer construction, which adds to the cost of the reformer. In addition, the temperature of the reformate exiting the reformer section is typically from about 600° C. to about 1000° C. Shift reactors usually have a maximum operating temperature of about 650° C., for high-temperature shift, to about 300° C., for low-temperature shift. This means that a fuel processing system employing an autothermal reformer and downstream shift reactor will generally also require high-temperature heat exchange elements therebetween to reduce the temperature of the reformate before introduction to the shift reactor. High-temperature heat exchange elements need to be made of expensive high-temperature materials and tend to use expensive heat exchange element designs if the system is designed for relatively high efficiency.

As another example, fuel efficiency of autothermal reformers tends to be lower relative to steam reformers. All else being equal, fuel usage in a reformer is proportional to heat recovery, and this tends to be lower for autothermal reformers.

As a further example, conventional fuel processing systems for fuel cell electric power generation systems employing autothermal reformers tend to have similar (about 1-5 hour) start-up times as mentioned previously. This is because such systems still employ shift reactors and the start-up time for this component becomes limiting despite the faster start-up time of the autothermal reformer.

Conventional fuel processing systems have attempted combining steam reforming and autothermal reforming. Generally, an autothermal reformer is coupled to a steam reformer so that the high-temperature reformate output of the autothermal reformer is used to provide some or all of the heat energy required to drive the endothermic steam reforming reaction in the downstream steam reformer. Approaches have employed autothermal and steam reformers connected in series, or combined within the same reformer vessel. These fuel processing systems tend to be less than desirable. First, while they arguably incorporate the benefits of autothermal and steam reformers, they also incorporate the disadvantages of each type of reformer, as well. Second, incorporating one of each type of reformer tends to undesirably increase the cost and complexity of the fuel processing system.

A first embodiment of the present apparatus and method comprises a steam reformer having a catalyst bed comprising a catalyst composition that is at least oxygen-tolerant, and means for supplying oxidant to the catalyst bed. As mentioned previously, any suitable steam reformer design may be used for the present apparatus, such as shell-and-tube or plate-and-frame designs, for example. The steam reformer may have a burner integrated within the reformer vessel, or a separate burner. Bayonet shell-and-tube designs employing integrated burners may be employed for their thermal efficiency and low-cost construction. However, the choice of basic steam reformer design may depend on other factors and will likely be determined at least in part by the operating parameters of the fuel processing system in which it is intended to be incorporated.

The present steam reformer incorporates the advantages of autothermal and steam reformers, while minimizing the disadvantages. For example, on start-up in conventional steam reformers employing reformer tubes, the reformer burner supplies heat to the exterior of the reformer tubes within the reformer vessel. The heat is then transferred to the catalyst bed via the reformer tube walls. Generally speaking, the rate at which the heat of the reformer burner combustion gases can be transferred to the catalyst bed is determined by the surface area of the reformer tube, and the heat transfer coefficients (specific heat transfer capacity). Once the specific heat transfer capacity of the reformer tubes has been reached, therefore, the rate of heating of the catalyst bed can only be achieved by increasing the burner flame mix temperature. Heating up the catalyst bed by increasing the burner flame mix temperature can disadvantageously increase thermal and mechanical stresses on the reformer tubes and other reformer components.

In the present steam reformer, fuel and oxidant can be supplied to the catalyst bed. Catalytic combustion takes place in the presence of the oxygen-tolerant catalyst, directly providing heat to the catalyst bed. Thus, start-up time may be decreased by providing an additional direct heat source for the catalyst bed that is not limited by the specific heat transfer capacity of the reactant tubes, as described above. Further, the additional direct heat source may decrease the mechanical stress on the reformer tubes and catalyst bed during start-up caused by the temperature differential between the interior of the catalyst bed and the exterior surfaces of the reformer tubes in direct thermal contact with the burner combustion gases.

Ignition of the catalytic combustion reaction within the catalyst bed during start-up may occur by heating up at least a portion of the catalyst bed to the minimum ignition temperature of the reactants in the presence of the catalyst composition.

For example, in a steam reformer comprising one or more reformer tubes, the tops of the reformer tube(s) may be heated externally by combustion gases from the reformer burner. After the tops of the reformer tube(s) have reached a suitable temperature, fuel and oxidant (and optionally, steam) are directed to the reformer tube(s). Ignition of the catalytic combustion reaction occurs when the reactant gases come into contact with the heated reformer tube walls near the top of the tube. By controlling the flow rate of the reactant gases, the reaction front can propagate back to the front portion of the bed, heating the entire catalyst bed. Other methods of heating at least a portion of the catalyst bed may also be suitable depending on the design and construction of the steam reformer. For example, a heating device, such as a resistive heating element, igniter, or glow plug could be placed within or near the catalyst bed, if desired. The flow rate of the reactant gases and the preheat temperature of the catalyst bed may also be controlled to ensure that the O₂/C ratio is such that carbon formation on the catalyst is avoided during start-up.

Once the operating temperature of the reformer has been reached, supply of oxidant to the reformer catalyst bed can be interrupted. The steam reformer can then be operated in the manner of a conventional steam reformer. This allows the present steam reformer to retain the benefit of quick start-up, much like an autothermal reformer, while also retaining the more efficient operation of a steam reformer once a suitable operating temperature has been achieved. Alternatively, supply of oxidant to the reformer catalyst bed can be maintained during operation of the present steam reformer.

In addition, the output of the present steam reformer can be increased, in response to peak demand, for example. In conventional steam reformers, hydrogen output is determined in part by the heat transfer capacity of the reformer tubes. That is, the amount of humidified fuel that can be reformed per unit time depends on the ability to maintain the catalyst bed at a temperature capable of maintaining the reforming reaction. Consequently, hydrogen output is related to the rate of heat transfer from the burner combustion gases to the catalyst bed, which is limited by the specific heat transfer capacity of the reformer tubes, as discussed above. One way to overcome this limitation and increase the output of the reformer is to increase the temperature of the reformer tubes by increasing the burner combustion temperature. This approach is generally undesirable, however, since it may necessitate the use of more costly high-temperature materials in reformer construction.

In the present steam reformer, oxidant can be supplied to the catalyst bed during normal operation. The heat of combustion of the fuel and/or reformed hydrogen is supplied directly to the catalyst bed as the oxidant reacts with the fuel and/or reformed hydrogen to produce heat. This may allow an increased throughput of reformed fuel through the reformer while maintaining the desired temperature within the catalyst bed. At the same time, the operating temperature of the present steam reformer may not be substantially increased, and the additional costs associated with high-temperature materials may be avoided, since the reformer tube(s) may be more isothermal. Of course, there is a trade-off in fuel efficiency for the increased output of the present steam reformer, as a portion of the fuel and/or reformed hydrogen is consumed in the catalytic combustion reaction. Once power demand levels decrease, however, the supply of oxidant to the catalyst bed can be interrupted, and normal operation resumed.

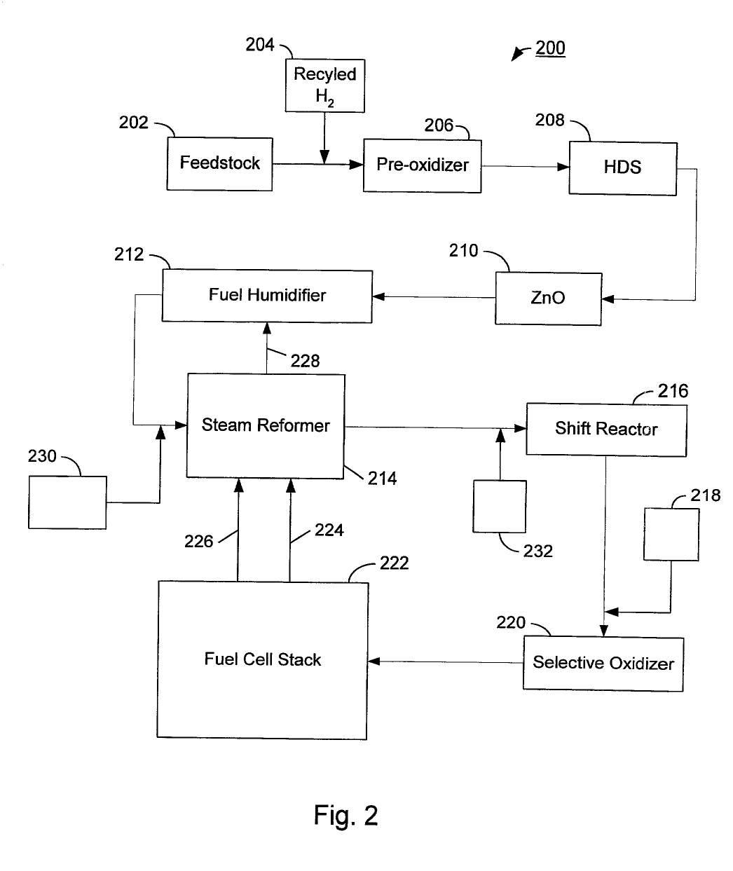

FIG. 2 is a schematic illustration of an embodiment of the present apparatus. Features of fuel processing system 200 similar to those of fuel processing system 100 in FIG. 1 are given similar numbers. Steam reformer 214 comprises the present steam reformer, as described above, having a catalyst bed comprising a catalyst composition that is at least oxygen-tolerant. During normal operation, oxidant from oxidant supply 230 may be mixed with the humidified fuel stream from humidifier 212 and supplied to steam reformer 214. Alternatively, oxidant could be supplied and mixed with the humidified fuel stream within reformer 214, or it may be added further upstream of reformer 214, if desired. The combustion of the fuel/oxidant mixture in the catalyst bed of reformer 214 provides additional heat on start-up or to support increased output from the reformer, as discussed above. The amount of oxidant added may be controlled such that essentially all of the oxygen is consumed in the catalytic combustion reactions.

The reformate is then supplied to shift reactor 216 where at least a portion of the carbon monoxide present in the reformate is converted into carbon dioxide and hydrogen according to the water gas shift reaction (II).

The reformate exiting shift reactor 216 is then supplied to selective oxidizer 220, wherein, a substantial amount of the remaining CO in the reformate stream is converted in the presence of oxygen into carbon dioxide within the selective oxidation catalyst bed. Selective oxidizer may comprise, for example, a single catalyst bed or a series of interconnected selective oxidation catalyst beds that may have separate oxidant inlets and/or heat exchange elements associated therewith. Selective oxidizer 220 may also further comprise a heating device, such as a resistive heating element, glow plug or igniter embedded in the catalyst bed for increasing the temperature of at least a portion of the catalyst bed on start-up, for example. Alternatively, selective oxidizer 220 may be heated by the combustion exhaust gas from an associated auxiliary burner, in which case the auxiliary burner would act as the heating device.

The present apparatus also comprises a fuel processing system and components thereof that employ shift reactors having shift catalyst beds comprising an oxygen-tolerant, self-reducing shift catalyst composition.

With respect to shift catalyst, the maximum operating temperature is the highest temperature the catalyst can sustain without being sintered or otherwise permanently deactivated.

An oxygen-tolerant shift catalyst composition is a catalyst with an oxidation exothermal temperature rise in the presence of a given concentration of oxygen gas and reformate that is less than the difference between the maximum operating temperature for the catalyst and the inlet temperature of the reactants introduced into the catalyst bed that starts the oxidation process.

A self-reducing catalyst composition is a catalyst that can be reduced in situ, in the presence of reformate (i.e., that does not require activation by pre-reduction prior to use). More specifically, a self-reducing catalyst composition has a reduction exothermal temperature rise in the presence of reformate that is less than the difference between the maximum operating temperature for the catalyst and the inlet temperature of the reformate introduced into the catalyst bed that starts the reduction process. Oxygen-tolerant, self-reducing catalyst compositions include, for example, bifunctional catalysts developed by Argonne National Laboratory (Argonne, Ill., USA) incorporating bimetallic/polymetallic oxide compositions. Suitable metals for use in the catalyst compositions include Pt, Ru, Pd, Pt/Ru, Pt/Cu, Co, Ag, Fe, Cu, and Mo. Suitable metal oxide supports include lanthanide oxides, manganese oxides, vanadium oxide, and mixed metal oxides. (See, for example, Myers et al., “Alternative Water-Gas Shift Catalyst Development”, in Transportation Fuel Cell Power Systems, 2000 Annual Progress Report, by U.S. Department of Energy. Washington, D.C., U.S. Department of Energy, October 2000.) Other catalyst compositions may also be suitable, providing that they meet the criteria for oxygen-tolerant, self-reducing catalyst compositions described above.

Optionally, shift reactor 216 may comprise an oxygen-tolerant, self-reducing shift catalyst composition.

On start-up, a small amount of oxidant from oxidant supply 232 can be supplied to shift reactor 216. Oxidant may be added to shift reactor alone, or it may be added thereto along with an inert gas, such as nitrogen, for example, or with reformate. Although FIG. 2 illustrates oxidant being added upstream of shift reactor 216, it is also possible to supply oxidant at the inlet of shift reactor 216, or directly into the shift catalyst bed, if desired.

A portion of the shift catalyst bed will be oxidized, generating heat and thereby increasing the temperature of the shift catalyst bed. Where oxidant and reformate are supplied to the shift catalyst bed, a portion of the oxidant may catalytically combust with raw fuel or hydrogen in the reformate in the presence of the shift catalyst to produce heat, as well. This may result in accelerated shift start-up. The amount of oxygen introduced into the shift catalyst bed may be controlled to ensure that the temperature rise due to the oxidation exothermal does not result in the shift catalyst exceeding its maximum operating temperature. The amount of oxygen that can be introduced into a shift catalyst bed of a given volume of catalyst while avoiding sintering or otherwise deactivating the catalyst is inversely related to the magnitude of the catalyst composition oxidation exothermal, and can easily be determined by persons skilled in the art.

Once a suitable bed temperature has been reached, the supply of oxidant can then be interrupted and normal operation of shift reactor 216 can commence.

The size of the shift reactor bed may be increased to account for the portion of the bed that would be oxidized, and therefore incapable of catalyzing the shift reaction on or shortly after start-up until the shift catalyst activity in this portion of the catalyst bed has been recovered. Once a suitable temperature is reached the supply of oxidant can be interrupted, however, and the oxidized portion of the bed would then self-reduce under normal operating conditions and be able to resume its normal operating performance.

For example, the shift catalyst bed may be heated to a temperature at or above the minimum operating temperature for initiation of the reduction reaction of the catalyst bed. Then, as the catalyst bed is reduced in the presence of reformate, the reduction exothermal temperature rise will further assist in bringing the shift catalyst bed up to normal operating temperature. Generally, the maximum inlet temperature of the reformate introduced into the shift catalyst bed (and the temperature of the shift catalyst bed itself) at this stage should not exceed a temperature defined by the maximum operating temperature of the shift catalyst minus the reduction exothermal temperature rise, otherwise the shift catalyst bed may be permanently damaged when the reduction exothermal occurs. The maximum inlet temperature for the reformate is system-dependent and may easily be determined for a given fuel processing system by those skilled in the art.

Thus, the use of an oxygen-tolerant, self-reducing shift catalyst may further decrease the start-up time of the present fuel processing system.

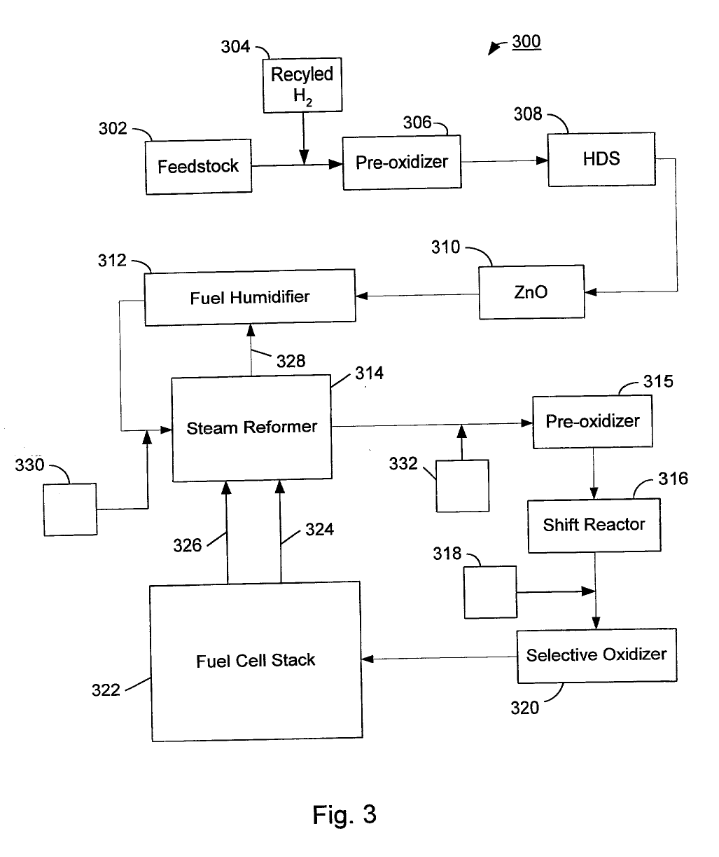

An alternative embodiment of the present apparatus is schematically illustrated in FIG. 3. Features of fuel processing system 300 similar to those of fuel processing system 200 in FIG. 2 and fuel processing system 100 in FIG. 1 are given similar numbers. In fuel processing system 300, a small amount of oxidant from oxidant supply 332 is mixed with reformate exiting steam reformer 314 and supplied to preoxidizer 315 upstream of shift reactor 316. Alternatively, oxidant could be supplied at the inlet of preoxidizer 315, or directly into the catalyst bed, if desired. Preoxidizer 315 comprises a catalytic combustion catalyst bed, such as platinum-containing catalyst, for example. Oxidant and a portion of the hydrogen in the reformate will catalytically combust in the presence of the oxidation catalyst, generating heat. The heated reformate stream is then directed to shift reactor 316 in order to heat the shift catalyst bed. In this embodiment, the shift catalyst need not be oxygen-tolerant and self-reducing, provided that the oxygen in the oxidant from oxidant supply 332 is essentially completely consumed in preoxidizer 315.

Provided there is hydrogen and oxygen present and the reactant temperature is above the minimum ignition temperature, then the reformate/oxidant mixture in preoxidizer 315 will self-ignite in the presence of the preoxidizer catalyst. Where the preoxidizer catalyst bed comprises non-sulfided platinum, for example, self-ignition will occur at room temperature. Where the minimum ignition temperature is significantly higher, preoxidizer 315 may further comprise a heating device, such as a resistive heating element, glow plug or igniter embedded in the catalyst bed for increasing the temperature of at least a portion of the catalyst bed to at least the desired minimum ignition temperature. Alternatively, preoxidizer 315 may be heated by the combustion exhaust gas from an associated auxiliary burner, in which case the auxiliary burner would act as the heating device.

If desired, however, shift reactor 316 may comprise an oxygen-tolerant, self-reducing catalyst composition, in which case excess oxidant may be supplied to preoxidizer 315 so that some oxidant is also introduced into shift reactor 316. Alternatively, fuel processing system 300 may further comprise an oxidant supply for supplying shift reactor 316 with oxidant, as discussed above in relation to fuel processing system 200 illustrated in FIG. 2.

Once shift reactor 316 has reached a suitable temperature, the supply of oxidant to preoxidizer 315 (and possibly, the supply of oxidant to shift reactor 316) may be interrupted. Essentially, preoxidizer 315 need only operate during start-up in order to more quickly raise the temperature of the shift reactor bed. During normal operation, the reformate stream exiting steam reformer 314 may pass through preoxidizer 315, or it may be by-passed and the reformate stream may be supplied directly to shift reactor 316.

In another embodiment of the present apparatus, start-up and operation of fuel processing system 300 is as described, except preoxidizer 315 in FIG. 3 is replaced with a first-stage selective oxidizer. The exothermic oxidation reactions occurring in the first-stage selective oxidizer would provide heat for shift reactor 316 and would also reduce the CO concentration in the reformate stream. During start-up the first-stage selective oxidizer could perform part or all of the function of shift reactor 316, at least until shift reactor 316 reached operating temperature. Employing a first-stage selective oxidizer, in combination with selective oxidizer 318 and possible partial performance of shift reactor 316 at increasing temperatures, the CO concentration of the reformate stream may be sufficiently reduced that a reformate stream having a desirable CO concentration (approximately 10 ppm sulfur, or less) may be supplied to fuel cell stack 322 sooner than would be the case in the absence of first-stage selective oxidation. Thus, a first-stage selective oxidizer may assist in decreasing the start-up time for fuel processing system 300, while also assisting in providing an acceptable reformate stream to fuel cell stack 322 at an earlier stage than conventional fuel processing systems.

The first-stage selective oxidizer may also comprise a heating device for increasing the temperature of at least a portion of the catalyst bed to at least the desired minimum ignition temperature, as discussed above in relation to preoxidizer 315. Unlike preoxidizer 315, however, the first-stage selective oxidizer may operate at all times during normal operation of fuel processing system 300.

In the embodiments of the present fuel processing system illustrated in FIGS. 2 and 3, sulfur is removed by an HDS and ZnO bed. However, other sulfur removal apparatus may also be suitable. Examples of a suitable sulfur removal apparatus include other metal oxide absorbent beds, zeolite adsorbents, or hot carbonate scrubbers. Other suitable sulfur removal apparatus will be apparent to persons skilled in the art.

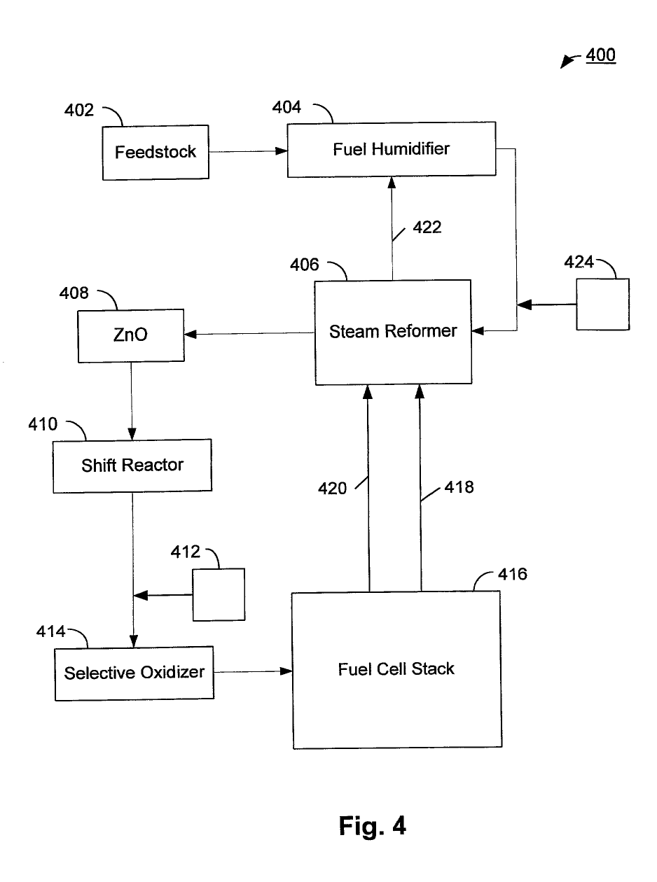

FIG. 4 is a schematic illustration of another embodiment of the present apparatus. In fuel processing system 400, raw fuel from supply 402 is supplied to fuel humidifier 404. The fuel is mixed with water and/or steam in humidifier 404 to produce a humidified fuel stream. The humidified fuel stream exiting humidifier 404 is then introduced into steam reformer 406. Steam reformer 406 comprises the present steam reformer, as previously described, having a catalyst bed comprising a catalyst composition that is at least sulfur-tolerant. The humidified fuel stream reacts in the catalyst bed of reformer 406 to produce a hydrogen-rich reformate stream containing CO₂, CO, raw fuel and water vapor. Where the raw fuel contains sulfur, the reformate stream may further comprise H₂S.

The reformate stream exiting reformer 406 is then passed over ZnO bed 408 where at least a portion of any H₂S present in the reformate stream is removed.

The reformate stream exiting ZnO bed 408 is then directed to shift reactor 410, in which shift catalyst converts the carbon monoxide in the reformate stream into carbon dioxide and hydrogen according to equation (II), above.

Optionally, shift reactor 410 may comprise an oxygen-tolerant, self-reducing shift catalyst, as discussed in relation to shift reactor 216 in fuel processing system 200, above. As set out above in relation to shift reactor 216, this would allow for the addition of oxidant to shift reactor 410 on start-up, and may result in accelerated shift start-up.

The reformate stream exiting shift reactor 410 is then mixed with oxidant from oxidant supply 412 and directed through selective oxidizer 414. Alternatively, oxidant could be supplied at the inlet of selective oxidizer 414, or directly into the catalyst bed, if desired. In selective oxidizer 414, the remaining CO in the reformate stream is substantially converted in the presence of oxygen into carbon dioxide. Typically, the reformate stream exiting selective oxidizer 414 contains less than 10 ppm CO.

The reformate stream exiting selective oxidizer 414 is then fed to fuel cell stack 416. Reformate supplied to the anodes of the fuel cells in stack 416, along with oxidant supplied to the cathodes thereof, generates electric power in stack 416. Anode and cathode exhaust 418 and 420, respectively, are fed to the burner of steam reformer 406 where they are combusted to provide at least a portion of the heat energy for the endothermic steam reforming reactions. Burner exhaust gas 422 is supplied to humidifier 404 to provide the heat energy for substantially vaporizing the water entrained in the fuel stream within humidifier 404.

Where the catalyst bed of steam reformer 406 comprises an oxygen-tolerant and sulfur-tolerant catalyst composition, fuel processing system 400 may further comprise oxidant supply 424. On demand, oxidant from oxidant supply 424 may be mixed with the humidified fuel stream from humidifier 404 and supplied to steam reformer 406. Alternatively, oxidant could be supplied and mixed with the humidified fuel stream within reformer 406 or further upstream. The combustion of the fuel and/or reformed hydrogen in the catalyst bed of reformer 406 provides additional heat on start-up or to support increased output from the reformer, as discussed above. If desired, oxidant may be supplied to reformer 406 continuously during normal operation. The amount of oxidant added may be controlled such that essentially all of the oxygen is consumed in the catalytic combustion reactions.

In particular cases where the catalyst composition requires a relatively hot minimum temperature for sulfur tolerance, the size of the reformer catalyst bed may be increased to account for the inlet portion of the catalyst bed that may be poisoned during normal operation. For example, Rh catalysts are known to be sulfur tolerant at temperatures above about 315° C. During normal operation, an upstream portion of the catalyst bed may initially be poisoned by sulfur in the fuel and would act only as a heat transfer surface. However, the downstream portion of the bed would be sufficiently heated to carry out the reforming reaction. By appropriately sizing the catalyst bed to account for the possible loss of activity of the upstream portion of the bed, operation and hydrogen output of the reformer may not be adversely affected.

Alternatively, or in addition to increasing the size of the catalyst bed, the addition of oxidant to the catalyst bed may also increase sulfur tolerance of the steam reforming catalyst. The added oxidant may readily oxidize any H₂S adsorbed on the catalyst producing SO₂. The heat produced on combustion of the oxidant with fuel and/or reformed hydrogen may also increase the temperature of the upstream portion of the bed, which may also assist in removing adsorbed H₂S. By controlling the amount of oxidant supplied to the catalyst bed, the upstream portion may be heated to a temperature at or above the minimum temperature for sulfur tolerance of the catalyst. Oxidant addition may be done periodically, if desired, either at a predetermined period or in response to a parameter indicative of decreasing catalytic activity such as reformer hydrogen output, for example.

Other methods may also be used to improve sulfur tolerance. A conventional method for regenerating sulfided steam reforming catalyst that may be employed is hot steam purging of the catalyst bed on shutdown. Given the ability of steam purging to strip sulfur from the reforming catalyst, it is expected that, generally, equilibrium sulfur levels on a steam reforming catalyst are a function of the concentration or partial pressure of steam over the catalyst. Accordingly, another method of increasing sulfur tolerance that may be employed in the present steam reformer and fuel processing system comprises increasing the steam-to-carbon ratio of the reactants fed to the reformer during normal operation. This may be done periodically, if desired, either at a predetermined period or in response to a parameter indicative of decreasing catalytic activity such as reformer hydrogen output, for example. Periodically increasing the steam-to-carbon ratio of the reactants can easily be accomplished with a load-following fuel cell electric power generation system at low power levels when the steam generator has extra capacity to generate steam relative to the fuel cell stack fuel flow rate.

If desired, periodically increasing the steam-to-carbon ratio of the reactants supplied to the catalyst bed may be combined with periodic addition of oxidant, as described above.

The present steam reformer employing catalyst compositions that are at least sulfur-tolerant is capable of reforming sulfur-containing fuels to produce primarily H₂S, which is easily absorbed by a downstream ZnO bed. As illustrated in FIG. 4, this may permit the design of a fuel processing system that is relatively simpler than conventional systems, since an HDS is not required. In addition, where the fuel may contain oxygen, such as peak shave gas, for example, the fuel processing system is further simplified as a preoxidizer and associated hydrogen recycle sub-system are also not required.

A trade-off in the present apparatus relates to ZnO sulfur absorption. The sulfur absorption equilibrium in a ZnO bed is related to the temperature of the bed and the water concentration in the reformate stream. In addition, the dilution of the sulfur concentration in the reformate relative to the raw fuel is also a factor. As a result, sulfur absorption equilibrium conditions are less favorable for a ZnO bed downstream of the reformer compared to an upstream ZnO bed.

Sulfur poisoning of shift reactor 410 may be a concern. Typically, the sulfur concentration in the reformate supplied to the shift reactor may be less than or equal to about 1 ppm, for example. However, even at 1 ppm sulfur, some poisoning of shift reactor 410 may occur. To compensate, shift reactor 410 may comprise a sacrificial upstream portion of the shift catalyst bed. The overall size of the shift catalyst bed may be increased to compensate for the loss of activity of the sacrificial portion.

Alternatively, shift reactor 410 may further comprise an integral upstream bed comprising a second reduced base metal absorbent, such as Cu—Zn-based compositions commercially available from Osaka Gas Co. Ltd. (Osaka, Japan). If oxygen-tolerant, self-reducing shift catalyst is employed in shift reactor 410, oxidant may be added on start-up, as discussed above, but should probably be added downstream of the reduced base metal absorbent bed.

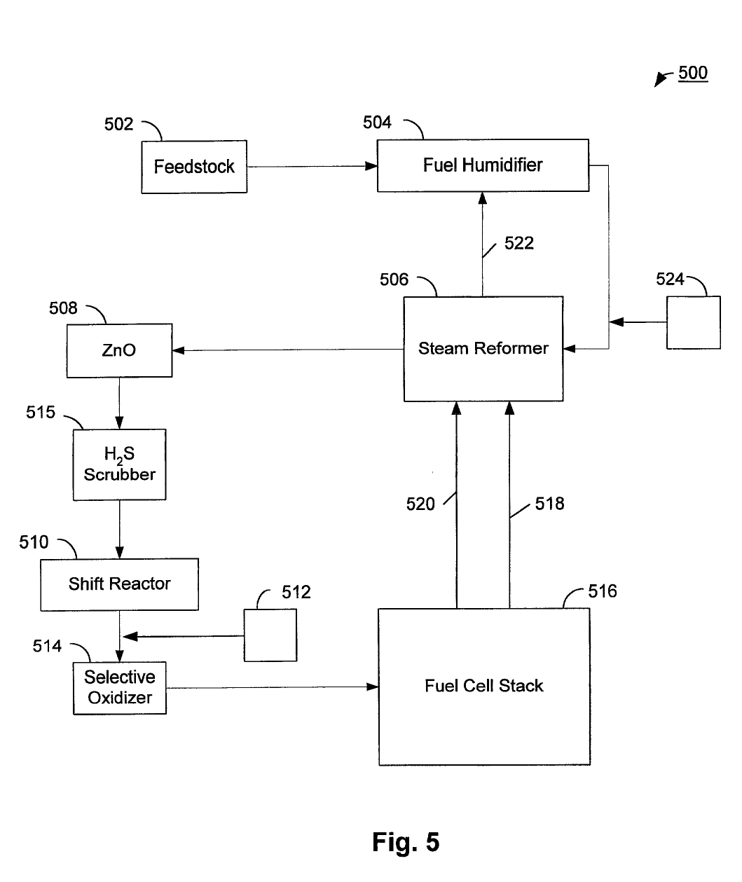

FIG. 5 is a schematic illustration of yet another embodiment of the present apparatus. Features of fuel processing system 500 similar to those of fuel processing system 400 in FIG. 4 are given similar numbers. In contrast to fuel processing system 400 in FIG. 4, fuel processing system 500 comprises a separate reduced base metal absorbent bed 509 downstream of ZnO bed 508. Absorbent bed 509 may be placed at any desired point downstream of ZnO bed 508 and upstream of fuel cell stack 516. Absorbent bed 509 may be located upstream of shift reactor 510, as illustrated in FIG. 5, so that trace sulfur will be removed from the reformate stream before introduction to the shift catalyst.

In all other material respects, the operation and function of shift reactor 510 in fuel processing system 500 is identical to the operation and function of shift reactor 410 in fuel processing system 400 described in FIG. 4. Thus, fuel processing system 500 may provide for a quick start-up time by adding controlled amounts of oxidant to steam reformer 506 comprising an oxygen-tolerant and sulfur-tolerant catalyst composition, and/or to shift reactor 510 comprising an oxygen-tolerant, self-reducing shift catalyst composition. Again, in the latter instance, oxidant should probably be added downstream of the reduced base metal absorbent bed.

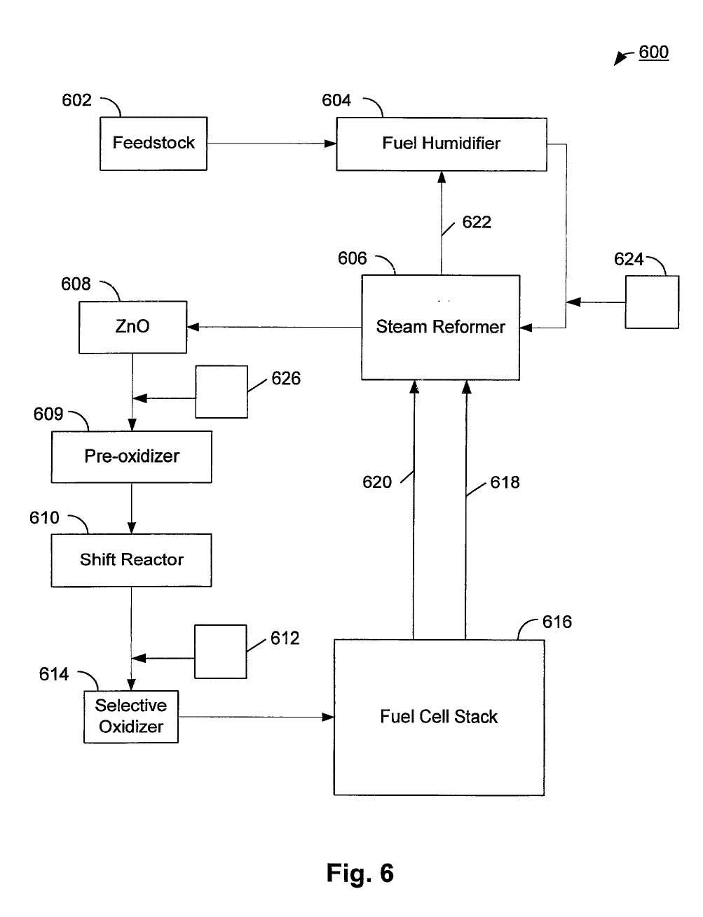

FIG. 6 is a schematic illustration of another embodiment of the present apparatus. Components of fuel processing system 600 similar to those of fuel processing system 400 in FIG. 4 and fuel processing system 500 in FIG. 5 are given similar numbers, and the operation and function of such components in fuel processing system 600 are essentially identical to the operation and function of like components in fuel processing systems 400 and 500. Fuel processing system 600 further comprises preoxidizer 609 located between ZnO bed 608 and shift reactor 610. In all material respects, the operation and function of preoxidizer 609 in fuel processing system 600 is identical to the operation and function of preoxidizer 315 in fuel processing system 300 described in FIG. 3. Thus, fuel processing system 600 may provide for a quick start-up time by adding controlled amounts of oxidant upstream of the reformer, and/or the shift reactor, to assist in heating the components of the system to their normal operating temperature.

Preoxidizer 609 may also be replaced by a first-stage selective oxidizer, thereby also allowing supply of hydrogen-rich reformate to the fuel cell stack at an earlier stage relative to conventional fuel processing systems, as discussed above in relation to fuel processing system 300 illustrated in FIG. 3.

In a further embodiment of the present apparatus, a metal oxide absorbent bed for H₂S removal and a shift reactor bed are combined in a single reactor vessel. The integrated reactor further comprises heat exchange elements to remove heat generated during the exothermic water shift reaction.

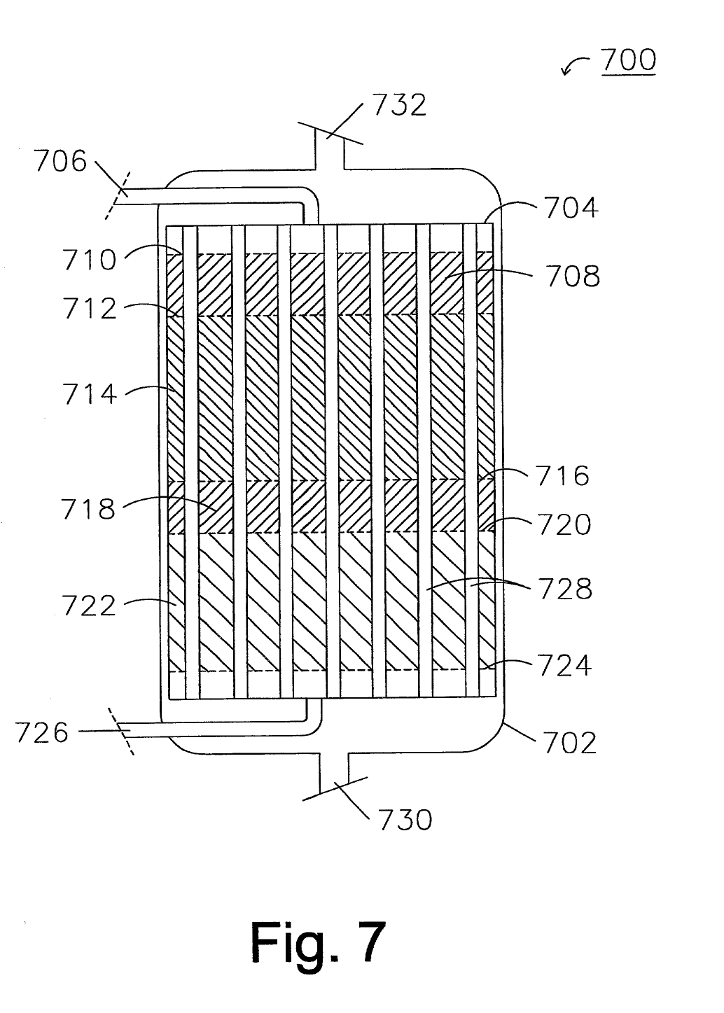

FIG. 7 is a schematic illustration in cross-section of an embodiment of the present integrated metal oxide absorbent bed and shift reactor. Integrated reactor 700 comprises vessel 702 and chamber 704 disposed therein. A reformate stream from an upstream reformer or other fuel processing system component is introduced into reactor 700 via reformate inlet 706 into chamber 704. The reformate stream may be introduced into an optional high-temperature shift catalyst bed 708, where a portion of the CO in the reformate stream is converted to carbon dioxide and hydrogen according to equation (II). In the embodiment of FIG. 7, high-temperature shift catalyst bed 708 is supported within chamber 704 by perforated plates 710 and 712, respectively.

The reformate stream is then introduced into ZnO bed 714, where a substantial portion of any H₂S present in the reformate stream is removed. In FIG. 7, ZnO bed 714 is supported within chamber 704 by perforated plates 712 and 716, respectively.

The reformate stream is then directed into bed 718 wherein substantially the remainder of H₂S in the reformate stream is removed. Bed 718 may comprise a sacrificial shift catalyst or another reduced base metal absorbent such as Cu—Zn-based compositions commercially available from Osaka Gas Co. Ltd. (Osaka, Japan). Bed 718 is similarly supported within chamber 704 by perforated plates 716 and 720, respectively.

After exiting bed 718, the reformate is then introduced to shift catalyst bed 722 comprising a medium-temperature and/or low-temperature shift catalyst, where a substantial portion of the CO in the reformate stream is converted to carbon dioxide and hydrogen according to equation (II). Shift catalyst bed 722 is supported within chamber 704 by perforated plates 720 and 724, respectively.

Other means for supporting the catalyst beds within chamber 704 may also be suitable. For example, screens may be employed or the catalyst beds could comprise catalyst monoliths, in which case no separate supports need be employed. Other suitable means for supporting the catalyst beds within chamber 704 will be apparent to those skilled in the art.

The reformate stream exiting shift catalyst bed 722 then exits reactor 700 via reformate outlet 726. Reformate inlet 706, reformer outlet 726, and chamber 704 are fluidly isolated from the interior of vessel 702. Heat transfer passages 728 extend through chamber 704 and are in thermal communication with the interior thereof. Cooling fluid, such as air, water or thermal oil, for example, is introduced into reactor 700 via inlet 730. The cooling fluid flows through heat transfer passages 728 and the space between the walls of vessel 702 and chamber 704, exiting via outlet 732.

Heat transfer passages 728 may be of any cross-sectional shape, and they may vary in diameter, cross-sectional shape, and/or length. They may extend axially, radially, or in any other direction through chamber 704. Other heat exchange elements may also be used instead of, or in addition to, heat transfer passages 724. For example, the exterior surface of chamber 704 may act as a heat exchange surface. As a further example, fins or heat exchange plates may be employed.

In the present integrated reactor, the hot reformate stream enters the front of the metal oxide bed, thereby heating it and/or sustaining a higher temperature in the upstream portion of the bed. Higher temperatures are advantageous for the absorbent capacity of the bed. As the reformate stream flows through the metal oxide bed it is cooled by heat exchange with the coolant fluid flowing through the integrated reactor. As a result, the downstream end of the metal oxide bed is significantly cooler than the front portion. Lower temperatures are advantageous for the H₂S absorption equilibrium. Thus, the temperature profile in the metal oxide bed may be controlled to increase the H₂S capacity of the front portion of the bed and shift the equilibrium in the downstream portion towards H₂S absorption, and may increase the ability of the metal oxide bed to remove sulfur from the reformate stream, relative to a more isothermal metal oxide bed.

Further, in the present integrated reactor, the metal oxide bed may increase the heat transfer coefficient of the heat exchange element as the reformate stream flows through the metal oxide bed, relative to, for example, a conventional shell-and-tube heat exchanger having an empty shell. In other words, the reformate stream may be more efficiently cooled to a temperature suitable for introduction to the downstream shift catalyst bed. Thus, the present integrated reactor may provide for more efficient heat exchange as compared to similar, separate components.

In addition, where the present integrated reactor comprises an upstream high-temperature shift catalyst bed a portion of the shift reaction occurs therein, generating heat. This heat may then be transferred to the upstream portion of the metal oxide bed, as described above. The increased heat may result in a higher temperature differential between the catalyst beds and the coolant fluid flowing through the heat exchange elements, and thus may increase the efficiency of heat exchange therebetween. Also, since a portion of the shift reaction occurs in the high-temperature shift catalyst bed, the amount of heat generated in the downstream shift catalyst bed may be lower because of the lower concentration of CO in the reformate stream. This, in turn, may reduce the cooling requirements of the downstream shift catalyst bed.

Integrated reactor 700 may be used in the present fuel processing system. For example, integrated reactor 700 could replace ZnO bed 408 and shift reactor 410 of fuel processing system 400 illustrated in FIG. 4, or ZnO bed 508, H₂S scrubber 515, and shift reactor 510 of fuel processing system 500 illustrated in FIG. 5.

In FIGS. 2-6, the various oxidant supplies are schematically illustrated separately. Of course, the present fuel processing system may employ a single oxidant supply or multiple oxidant supplies, as desired.

In addition, the embodiments of the present fuel processing system of FIGS. 2-6 illustrate a fuel humidifier. Other arrangements are also suitable. For example, water and/or steam could be supplied directly to the steam reformer and the fuel humidifier could be eliminated, if desired.

Further, although the embodiments of the present fuel processing system of FIGS. 2-6 illustrate a ZnO bed, other suitable metal oxide absorbent beds may be employed to remove H₂S from the reformate stream, if desired.

If desired, the present fuel processing system may further comprise a high-temperature shift reactor located downstream of the present steam reformer before any other components. In particular, a high-temperature shift reactor comprising a sulfur-tolerant catalyst composition, such as conventional iron oxide shift catalysts, for instance, may be used in the embodiments of the present fuel processing system illustrated in FIGS. 4-6.

Other components may also be suitable in the present fuel processing system, such as alternate components for removing CO from the reformate stream. For example, a pressure swing adsorption (PSA) unit may replace the selective oxidizer in any of FIGS. 2-6, if desired. Alternatively, a PSA unit could also further replace the shift reactor, along with any associated preoxidizers/selective oxidizers.

Where the steam reformer employs a sulfur-tolerant catalyst composition and the fuel processing system employs downstream sulfur removal, a PSA unit may also further replace the downstream sulfur removal apparatus. Other sulfur removal apparatus, such as hot carbonate scrubbers, for example, may also be employed in place of the illustrated sulfur removal apparatus.

In addition, the present fuel processing system may further comprise a hydrogen separation unit comprising a hydrogen separation membrane located downstream of the selective oxidizer. Alternatively, a hydrogen separation unit could further replace the shift reactor, along with any associated preoxidizers/selective oxidizers. And a hydrogen separation unit could be combined with an upstream PSA unit, if desired. Where the fuel does not contain sulfur, it may be possible to replace all equipment downstream of the steam reformer with a hydrogen separation unit.

Where the present fuel processing system employs a shift reactor having a catalyst bed comprising an oxygen-tolerant, self-reducing catalyst composition, the fuel processing system need not be limited to ones employing a steam reformer. In such cases, any suitable reformer may be employed.

Of course, the present steam reformer and fuel processing system may be employed to process fuels that do not contain sulfur. For example, methanol may not contain sulfur depending on the method of production. Zero-sulfur liquid synthetic hydrocarbon fuels are also available. Where the fuel does not contain sulfur, the present fuel processing apparatus may omit the sulfur removal apparatus.

Finally, while the present fuel processing system and components thereof have been illustrated for use in supplying reformate to an associated fuel cell stack, they are not confined to such applications. The present fuel processing system and components thereof may find use in other applications requiring the processing of a fuel into a reformate stream comprising hydrogen.

While particular elements, embodiments and applications of the present invention have been shown and described, it will be understood, of course, that the invention is not limited thereto since modifications may be made by those skilled in the art, particularly in light of the foregoing teachings. It is therefore contemplated that the appended claims cover such modifications as incorporate those features that come within the scope of the invention.

What is claimed is:

1. A steam reformer for converting a fuel into a reformate stream, said reformer comprising:
(a) a closed vessel;
(b) a catalyst bed disposed within said vessel, said catalyst bed comprising a catalyst composition that is at least oxygen-tolerant;
(c) a reactant inlet for directing a reactant stream to said catalyst bed, said reactant comprising said fuel; and
(d) an oxidant inlet for directing an oxidant to said catalyst bed.

2. The reformer of claim 1 wherein said catalyst composition comprises a noble metal compound.

3. The reformer of claim 1 wherein said catalyst composition is also sulfur-tolerant.

4. The reformer of claim 1, further comprising a burner disposed within said vessel.

5. The reformer of claim 1, further comprising at least one reformer tube disposed within said vessel, wherein said catalyst bed is disposed within said at least one reformer tube.

6. The reformer of claim 5 wherein said at least one reformer tube comprises a plurality of reformer tubes.

7. The reformer of claim 5, further comprising a burner disposed within said vessel.

8. A fuel processing system for converting a fuel into a reformate stream, said fuel processing system comprising the steam reformer of claim 1.

9. A fuel processing system for converting a fuel into a reformate stream, said fuel processing system comprising the steam reformer of claim 2.

10. A fuel processing system for converting a fuel into a reformate stream, said fuel processing system comprising the steam reformer of claim 3.

11. A fuel processing system for converting a fuel into a reformate stream, said fuel processing system comprising the steam reformer of claim 7.

12. A fuel processing system for converting a fuel into a reformate stream, said fuel processing system comprising:
(a) a steam reformer having at least one catalyst bed disposed therein, said at least one catalyst bed comprising a catalyst composition that is at least oxygen-tolerant; and
(b) an oxidant supply adapted to supply an oxidant to said catalyst bed.

13. The fuel processing system of claim 12 wherein said oxidant supply is located upstream of said steam reformer and fluidly connected thereto.

14. The fuel processing system of claim 12, further comprising a hydrogen separation unit located downstream of said steam reformer and fluidly connected thereto, said hydrogen separation unit comprising at least one hydrogen separation membrane.

15. The fuel processing system of claim 12, further comprising a pressure swing adsorption unit located downstream of said steam reformer and fluidly connected thereto.

16. The fuel processing system of claim 12, further comprising a shift reactor located downstream of said steam reformer and fluidly connected thereto, said shift reactor comprising a shift catalyst bed.

17. The fuel processing system of claim 16, further comprising a pressure swing adsorption unit located downstream of said shift reactor and fluidly connected thereto.

18. The fuel processing system of claim 16, further comprising a selective oxidizer located downstream of said shift reactor and fluidly connected thereto.

19. The fuel processing system of claim 12, further comprising:
(c) a preoxidizer located downstream of said steam reformer and fluidly connected thereto;
(d) a shift reactor located downstream of said preoxidizer and fluidly connected thereto, said shift reactor comprising a shift catalyst bed; and
(e) a selective oxidizer located downstream of said shift reactor and fluidly connected thereto.

20. The fuel processing system of claim 12, further comprising:
(c) a first selective oxidizer located downstream of said steam reformer and fluidly connected thereto;
(d) a shift reactor located downstream of said first selective oxidizer and fluidly connected thereto, said shift reactor comprising a shift catalyst bed; and
(e) a second selective oxidizer located downstream of said shift reactor and fluidly connected thereto.

21. The fuel processing system of any one of claims 16-20, wherein said shift catalyst bed comprises an oxygen-tolerant, self-reducing catalyst composition.

22. The fuel processing system of any one of claims 16-20, wherein said shift catalyst bed comprises an oxygen-tolerant, self-reducing catalyst composition, further comprising an oxidant supply adapted to supply oxidant to said shift reactor.

23. The fuel processing system of claim 12, further comprising a sulfur removal apparatus located upstream of said steam reformer and fluidly connected thereto.

24. The fuel processing system of claim 16, further comprising a sulfur removal apparatus located upstream of said steam reformer and fluidly connected thereto.

25. The fuel processing system of any one of claims 23 and 24 wherein said sulfur removal apparatus is selected from the group consisting of hydrodesulfurizers and metal oxide beds, zeolite adsorbent beds, and hot carbonate scrubbers.

26. The fuel processing system of claim 25 wherein said sulfur removal apparatus comprises a hydrodesulfurizer located upstream of said steam reformer, and a metal oxide bed interposed between said hydrodesulfurizer and said steam reformer and fluidly connected to both.

27. The fuel processing system of claim 26, wherein said metal oxide bed comprises zinc oxide.

28. The fuel processing system of claim 12, further comprising a fuel cell stack located downstream of said steam reformer and fluidly connected thereto.

29. The fuel processing system of claim 28 wherein said stack is a solid polymer electrolyte fuel cell stack.

30. The fuel processing system of claim 12, further comprising:
(c) a shift reactor located downstream of said steam reformer and fluidly connected thereto, said shift reactor comprising a shift catalyst bed comprising an oxygen-tolerant, self-reducing catalyst composition; and
(d) a fuel cell stack located downstream of said shift reactor and fluidly connected thereto for receiving said reformate stream.

31. The fuel processing system of claim 30 wherein said stack is a solid polymer electrolyte fuel cell stack.

32. A method of initiating operation of a fuel processing system of comprising a steam reformer having at least one catalyst bed disposed therein, said at least one catalyst bed comprising a catalyst composition that is at least oxygen-tolerant and an oxidant supply adapted to supply an oxidant to said catalyst bed, said method comprising:
(a) heating at least a portion of said at least one catalyst bed to a predetermined ignition temperature; and
(b) supplying reactants comprising said fuel and said oxidant to said at least one catalyst bed and catalytically combusting at least a portion of said fuel and said oxidant therein to supply heat thereto.

33. The method of claim 32 wherein said fuel processing system further comprises a burner associated with said steam reformer, and wherein step (a) comprises directing a combustion gas stream from said burner in thermal communication with said at least one catalyst bed to heat at least a portion thereof.

34. The method of claim 32, further comprising interrupting the supply of oxidant when substantially all of said at least one catalyst bed at least reaches a predetermined threshold temperature.

35. The method of claim 32 wherein said reactants further comprise steam and said method further comprises reforming a portion of said fuel in said at least one catalyst bed to produce a reformate stream.

36. The method of claim 32, further comprising supplying steam to said at least one catalyst bed, and reforming a portion of said fuel in said at least one catalyst bed to produce a reformate stream.

37. The method of claim 36, wherein said fuel processing system further comprises:
a shift reactor located downstream of said steam reformer and fluidly connected thereto for receiving a gas stream, said shift reactor comprising a shift catalyst bed comprising an oxidant-tolerant, self-reducing catalyst composition; and
an oxidant supply adapted to supply an oxidant to said shift reactor;
the method further comprising:
(c) supplying said oxidant to said shift reactor and generating heat by oxidizing at least a portion of said shift catalyst bed; and
(d) interrupting supply of said oxidant to said shift reactor when at least a portion of said shift catalyst bed reaches a predetermined threshold temperature.

38. The method of claim 37, further comprising supplying said gas stream and said oxidant to said shift reactor, wherein said gas stream comprises said reformate or an inert gas.

39. The method of claim 37 wherein said threshold temperature is the minimum operating temperature of said shift catalyst bed.

40. The method of claim 36 wherein said fuel processing system further comprises:
a preoxidizer located downstream of said steam reformer and fluidly connected thereto for receiving said reformate stream;
a shift reactor located downstream of said preoxidizer and fluidly connected thereto, said shift reactor comprising a shift catalyst bed; and
an oxidant supply adapted to supply an oxidant to said preoxidizer;
the method further comprising:
(c) supplying said reformate stream and said oxidant to said preoxidizer and catalytically combusting at least a portion of said reformate stream and said oxidant therein to produce a heated reformate stream;
(d) supplying said heated reformate stream to said shift reactor to heat said shift catalyst bed; and
(e) interrupting supply of said oxidant to said preoxidizer when at least a portion of said shift catalyst bed reaches a predetermined threshold temperature.

41. The method of claim 40 wherein substantially all of said oxidant supplied to said preoxidizer is consumed therein.

42. The method of claim 40 wherein said shift catalyst bed comprises an oxidant-tolerant, self-reducing catalyst composition.

43. The method of claim 42 wherein a portion of said oxidant supplied to said preoxidizer is supplied to said shift reactor and generates heat by oxidizing at least a portion of said shift catalyst bed.

44. The method of claim 42 wherein said fuel processing system further comprises an oxidant supply adapted to supply an oxidant to said shift reactor, said method further comprising:
(f) supplying a gas stream comprising said oxidant to said shift reactor to oxidize at least a portion of said shift catalyst bed; and
(g) interrupting supply of said gas stream to said shift reactor when said at least a portion of said shift catalyst bed reaches a predetermined threshold temperature.

45. The method of claim 44 wherein said gas stream further comprises an inert gas.

46. The method of claim 44, further comprising supplying said gas stream and said heated reformate stream to said shift reactor.

47. The method of claim 44 wherein said threshold temperature is the minimum operating temperature of said shift catalyst bed.

48. A method of operating the fuel processing system of claim 12, said method comprising:
(c) supplying said fuel and said steam to said at least one catalyst bed and reforming a portion of said fuel therein; and
(d) supplying said oxidant to said at least one catalyst bed and catalytically combusting a portion of said fuel and said oxidant therein.

49. The method of claim 48 wherein said oxidant supply is located upstream of said steam reformer and fluidly connected thereto.

50. The method of claim 48 wherein the supply of oxidant to said at least one catalyst bed is adjusted in response to output requirements of said fuel processing system.

51. The method of claim 50, further comprising interrupting supplying said oxidant to said at least one catalyst bed in response to output requirements of said fuel processing system.

52. A fuel processing system for converting a fuel into a reformate stream, said fuel processing system comprising:
(a) a steam reformer having at least one catalyst bed disposed therein, said at least one catalyst bed comprising a catalyst composition that is at least sulfur-tolerant; and
(b) a sulfur removal apparatus located downstream of said steam reformer and fluidly connected thereto.

53. The fuel processing system of claim 52, further comprising a hydrogen separation unit located downstream of said sulfur removal apparatus and fluidly connected thereto, said hydrogen separation unit comprising at least one hydrogen separation membrane.

54. The fuel processing system of claim 52, further comprising a shift reactor located downstream of said sulfur removal apparatus and fluidly connected thereto, said shift reactor comprising a shift catalyst bed.

55. The fuel processing system of claim 54, further comprising a selective oxidizer located downstream of said shift reactor and fluidly connected thereto.

56. The fuel processing system of claim 54, further comprising a pressure swing adsorption unit located downstream of said shift reactor and fluidly connected thereto.

57. The fuel processing system of claim 54, further comprising a preoxidizer located between said sulfur removal apparatus and said shift reactor and fluidly connected to both.

58. The fuel processing system of claim 52, further comprising:
(c) a first selective oxidizer located downstream of said sulfur removal apparatus and fluidly connected thereto;
(d) a shift reactor located downstream of said first selective oxidizer and fluidly connected thereto, said shift reactor comprising a shift catalyst bed; and
(e) a second selective oxidizer located downstream of said shift reactor and fluidly connected thereto.

59. The fuel processing system of any one of claims 54-58, wherein said shift catalyst bed comprises an oxygen-tolerant, self-reducing catalyst composition.

60. The fuel processing system of any one of claims 54-58, wherein said shift catalyst bed comprises an oxygen-tolerant, self-reducing catalyst composition, further comprising an oxidant supply adapted to supply oxidant to said shift reactor.

61. The fuel processing system of claim 52, further comprising a shift reactor located downstream of said steam reformer and fluidly connected thereto, said shift reactor having a shift catalyst bed comprising a high-temperature shift catalyst composition.

62. The fuel processing system of any one of claims 52-58, wherein said sulfur removal apparatus is selected from the group consisting of pressure swing adsorption units, metal oxide beds, reduced base metal absorbent beds, hot carbonate scrubbers, or combinations thereof.

63. The fuel processing system of any one of claims 52-58, wherein said sulfur removal apparatus is selected from the group consisting of pressure swing adsorption units, metal oxide beds, reduced base metal absorbent beds, hot carbonate scrubbers, or combinations thereof, and wherein said sulfur removal apparatus comprises a metal oxide bed.

64. The fuel processing system of any one of claims 52-58, wherein said sulfur removal apparatus is selected from the group consisting of pressure swing adsorption units, metal oxide beds, reduced base metal absorbent beds, hot carbonate scrubbers, or combinations thereof, wherein said sulfur removal apparatus comprises a metal oxide bed, and wherein said sulfur removal apparatus further comprises a reduced base metal absorbent bed.

65. The fuel processing system of any one of claims 52-58, wherein said sulfur removal apparatus is selected from the group consisting of pressure swing adsorption units, metal oxide beds, reduced base metal absorbent beds, hot carbonate scrubbers, or combinations thereof, and wherein said sulfur removal apparatus comprises a metal oxide bed, and wherein said metal oxide bed comprises zinc oxide.

66. The fuel processing system of any one of claims 52-58 wherein said at least one catalyst bed of said steam reformer comprises an oxygen-tolerant and sulfur-tolerant catalyst composition, said fuel processing system further comprising an oxidant supply adapted to supply an oxidant to said catalyst bed of said steam reformer.

67. The fuel processing system of claim 52, further comprising a fuel cell stack located downstream of said steam reformer and fluidly connected thereto for receiving said reformate stream.

68. The fuel processing system of claim 67 wherein said stack is a solid polymer electrolyte fuel cell stack.

69. The fuel processing system of claim 52, wherein said at least one catalyst bed of said steam reformer comprises an oxygen-tolerant and sulfur-tolerant catalyst composition, said fuel processing system further comprising an oxidant supply adapted to supply an oxidant to said catalyst bed.

70. The fuel processing system of claim 69, further comprising a fuel cell stack located downstream of said steam reformer and fluidly connected thereto for receiving said reformate stream.

71. The fuel processing system of claim 70 wherein said stack is a solid polymer electrolyte fuel cell stack.

72. A method of operating a fuel processing system comprising a steam reformer having at least one catalyst bed disposed therein, said at least one catalyst bed comprising a catalyst composition that is at least sulfur-tolerant, and a sulfur removal apparatus located downstream of said steam reformer and fluidly connected thereto, said method comprising:
(a) supplying said fuel and said steam to said at least one catalyst bed and reforming a portion of said fuel therein into a reformate stream comprising hydrogen and hydrogen sulfide; and
(b) supplying said reformate stream to said sulfur removal apparatus to reduce the concentration of said hydrogen sulfide in said reformate stream to below a predetermined threshold concentration.

73. The method of claim 72 wherein said sulfur removal apparatus is selected from the group consisting of pressure swing adsorption units, metal oxide beds, reduced base metal absorbent beds, hot carbonate scrubbers, and combinations thereof.

74. The method of claim 73 wherein said sulfur removal apparatus comprises a metal oxide bed.

75. The method of claim 74 wherein said sulfur removal apparatus further comprises a reduced base metal absorbent bed.

76. The method of claim 74 wherein said metal oxide bed comprises zinc oxide.

77. The method of claim 72 wherein said threshold concentration is less than about 1 ppm.

78. The method of claim 72 wherein said threshold concentration is less than about 0.5 ppm.

79. The method of claim 72, further comprising transiently increasing the amount of said steam supplied to said at least one catalyst bed relative to the amount of fuel supplied thereto.

80. The method of claim 79 wherein the amount of said steam supplied to said at least one catalyst bed is increased intermittently.

81. The method of claim 80 wherein the amount of said steam supplied to said at least one catalyst bed is adjusted in response to a measured parameter indicative of decreasing activity of said catalyst composition.

82. The method of claim 72 wherein said at least one catalyst bed of said steam reformer comprises an oxygen-tolerant and sulfur-tolerant catalyst composition, and said fuel processing system further comprises an oxidant supply adapted to supply an oxidant to said catalyst bed, said method further comprising supplying said oxidant to said at least one catalyst bed and catalytically combusting a portion of said fuel and said oxidant therein.

83. The method of claim 82 wherein the supply of oxidant to said at least one catalyst bed is adjusted in response to output requirements of said fuel processing system.

84. The method of claim 83, further comprising interrupting supplying said oxidant to said at least one catalyst bed in response to output requirements of said fuel processing system.

85. The method of claim 82 wherein said at least one catalyst bed of said steam reformer comprises an oxygen-tolerant and sulfur-tolerant catalyst composition, and said fuel processing system further comprises an oxidant supply adapted to supply an oxidant to said catalyst bed, said method further comprising supplying said oxidant to said at least one catalyst bed and catalytically combusting a portion of said fuel and said oxidant therein.

86. The method of claim 85 wherein the supply of oxidant to said at least one catalyst bed is adjusted in response to a measured parameter indicative of decreasing activity of said catalyst composition.

87. The method of claim 85, further comprising interrupting supplying said oxidant to said at least one catalyst bed in response to a measured parameter indicative of decreasing activity of said catalyst composition.

88. The method of claim 85 wherein the amount of said steam supplied to said at least one catalyst bed is increased intermittently.

89. The method of claim 88 wherein the amount of said steam supplied to said at least one catalyst bed is adjusted in response to a measured parameter indicative of decreasing activity of said catalyst composition.

90. A fuel processing system for converting a fuel into a reformate stream, said fuel processing system comprising:
(a) a reformer;
(b) a preoxidizer located downstream of said reformer and fluidly connected thereto, said preoxidizer comprising a combustion catalyst bed;
(c) a shift reactor located downstream of said preoxidizer and fluidly connected thereto, said shift reactor comprising a shift catalyst bed; and
(d) an oxidant supply adapted to supply an oxidant to said preoxidizer.

91. The fuel processing system of claim 90 wherein said preoxidizer further comprises a heating device for heating said combustion catalyst bed.

92. The fuel processing system of claim 90 wherein said shift catalyst bed comprises an oxygen-tolerant, self-reducing catalyst composition.

93. The fuel processing system of claim 92, further comprising an oxidant supply adapted to supply oxidant to said shift reactor.

94. The fuel processing system of claim 92, further comprising a selective oxidizer located downstream of said shift reactor and fluidly connected thereto.

95. The fuel processing system of claim 90, further comprising a fuel cell stack located downstream of said steam reformer and fluidly connected thereto for receiving said reformate stream.

96. The fuel processing system of claim 95 wherein said stack is a solid polymer electrolyte fuel cell stack.

97. A method of initiating operation of a fuel processing system comprising:
a reformer;
a preoxidizer located downstream of said reformer and fluidly connected thereto, said preoxidizer comprising a combustion catalyst bed;
a shift reactor located downstream of said preoxidizer and fluidly connected thereto, said shift reactor comprising a shift catalyst bed; and
an oxidant supply adapted to supply an oxidant to said preoxidizer;
the method comprising:
(a) supplying said reformate stream and said oxidant to said preoxidizer and catalytically combusting at least a portion of said reformate stream and said oxidant therein to produce a heated reformate stream;
(b) supplying said heated reformate stream to said shift reactor to heat said shift catalyst bed; and
(c) interrupting supply of said oxidant to said preoxidizer when at least a portion of said shift catalyst bed reaches a predetermined threshold temperature.

98. The method of claim 97, further comprising heating at least a portion of said combustion catalyst bed to a predetermined ignition temperature before supplying said reformate stream and said oxidant thereto.

99. The method of claim 97 wherein substantially all of said oxidant supplied to said preoxidizer is consumed therein.

100. The method of claim 99 wherein said threshold temperature is the minimum operating temperature of said shift catalyst bed.

101. The method of claim 97 wherein said shift catalyst bed comprises an oxidant-tolerant, self-reducing catalyst composition.

102. The method of claim 101 wherein a portion of said oxidant supplied to said preoxidizer is supplied to said shift reactor and generates heat by oxidizing at least a portion of said shift catalyst bed.

103. The method of claim 101 wherein said fuel processing system further comprises an oxidant supply adapted to supply an oxidant to said shift reactor, said method further comprising supplying a gas stream comprising said oxidant to said shift reactor to oxidize at least a portion of said shift catalyst bed, and interrupting supply of said oxidant to said shift reactor when at least a portion of said shift catalyst bed reaches a predetermined threshold temperature.

104. The method of claim 103 wherein said gas stream further comprises an inert gas.

105. The method of claim 103, further comprising supplying said gas stream and said heated reformate stream to said shift reactor.

106. A method of initiating operation of a fuel processing system for converting a fuel into a reformate stream, said fuel processing system comprising:
a reformer;
a shift reactor located downstream of said reformer and fluidly connected thereto for receiving a gas stream, said shift reactor comprising a shift catalyst bed comprising an oxidant-tolerant, self-reducing catalyst composition; and
an oxidant supply adapted to supply an oxidant to said shift reactor;
the method comprising:
(a) supplying said oxidant to said shift reactor and generating heat by oxidizing at least a portion of said shift catalyst bed; and
(b) interrupting supply of said oxidant to said shift reactor when substantially all of said shift catalyst bed at least reaches a predetermined threshold temperature.

107. The method of claim 106, further comprising supplying said gas stream and said oxidant to said shift reactor, wherein said gas stream comprises said reformate or an inert gas.

108. The method of claim 106 wherein said threshold temperature is the minimum operating temperature of said shift catalyst bed.

109. A fuel processing system for converting a fuel into a reformate stream, said fuel processing system comprising:
(a) a reformer;
(b) a first selective oxidizer located downstream of said reformer and fluidly connected thereto, said first selective oxidizer comprising a selective oxidation catalyst bed;
(c) a shift reactor located downstream of said first selective oxidizer and fluidly connected thereto, said shift reactor comprising a shift catalyst bed;
(d) a second selective oxidizer located downstream of said shift reactor and fluidly connected thereto; and
(e) at least one oxidant supply adapted to supply an oxidant to said first and second selective oxidizers.

110. The fuel processing system of claim 109 wherein said first selective oxidizer further comprises a heating device for heating said selective oxidation catalyst bed.

111. The fuel processing system of claim 109 wherein said shift catalyst bed comprises an oxygen-tolerant, self-reducing catalyst composition.

112. The fuel processing system of claim 111, further comprising an oxidant supply adapted to supply oxidant to said shift reactor.

113. The fuel processing system of claim 109, further comprising a fuel cell stack located downstream of said steam reformer and fluidly connected thereto for receiving said reformate stream.

114. The fuel processing system of claim 113 wherein said stack is a solid polymer electrolyte fuel cell stack.

115. A method of initiating operation of a fuel processing system comprising:
a reformer;
a first selective oxidizer located downstream of said reformer and fluidly connected thereto, said first selective oxidizer comprising a selective oxidation catalyst bed;
a shift reactor located downstream of said first selective oxidizer and fluidly connected thereto, said shift reactor comprising a shift catalyst bed;
a second selective oxidizer located downstream of said shift reactor and fluidly connected thereto; and
at least one oxidant supply adapted to supply an oxidant to said first and second selective oxidizers,
the method comprising:
(a) supplying said reformate stream and said oxidant to said first selective oxidizer and catalytically oxidizing at least a portion of the carbon monoxide present in said reformate stream to produce a heated reformate stream;
(b) supplying said heated reformate stream to said shift reactor; and
(c) supplying said heated reformate stream from said shift reactor and said oxidant to said second selective oxidizer to reduce the concentration of said carbon monoxide in said reformate stream to below a predetermined threshold concentration.

116. The method of claim 115, further comprising heating at least a portion of said selective oxidation catalyst bed of said first selective oxidizer to a predetermined ignition temperature before supplying said reformate stream and said oxidant thereto.

117. The method of claim 115 wherein said threshold concentration is less than or equal to about 10 ppm.

118. The method of claim 117 wherein said fuel processing system further comprises a fuel cell stack located downstream of said second selective oxidizer, said method comprising supplying said reformate stream from said second selective oxidizer to the anodes of the fuel cells of said stack.

119. The method of claim 118 wherein said fuel cells are solid polymer electrolyte fuel cells.

120. An integrated reactor comprising:
(a) a closed vessel having a reformate inlet and a reformate outlet for receiving and discharging, respectively, a reformate stream, and having a coolant inlet and a coolant outlet for receiving and discharging, respectively, a coolant fluid stream;
(b) a metal oxide bed disposed within said vessel and in fluid communication with said reformate inlet;
(c) a shift catalyst bed disposed within said vessel downstream of said metal oxide bed, said shift catalyst bed in fluid communication with said metal oxide bed and said reformate outlet; and
(d) at least one heat exchange element in fluid communication with said coolant inlet and said coolant outlet, and in thermal communication with said metal oxide bed and said shift catalyst bed,
wherein said at least one heat exchange element is fluidly isolated from said metal oxide bed and said shift catalyst bed.

121. The integrated reactor of claim 120 wherein said metal oxide bed comprises zinc oxide.

122. The integrated reactor of claim 120, further comprising a reduced base metal absorbent bed interposed between and in fluid communication with said metal oxide bed and said shift catalyst bed.

123. The integrated reactor of claim 122 wherein said reduced base metal absorbent bed comprises a copper-zinc compound.

124. The integrated reactor of claim 123 wherein said metal oxide bed comprises zinc oxide.

125. The integrated reactor of claim 120, further comprising a high-temperature shift catalyst bed disposed between and in fluid communication with said reformate inlet and said metal oxide bed.

126. The integrated reactor of claim 122, further comprising a high-temperature shift catalyst bed disposed between and in fluid communication with said reformate inlet and said metal oxide bed.

127. The integrated reactor of claim 120 wherein said coolant fluid stream comprises a stream selected from the group consisting of air, water, and thermal oils.

128. The integrated reactor of claim 120, further comprising a chamber disposed within said vessel, said chamber in fluid communication with said reformate inlet and said reformate outlet, and wherein said metal oxide bed and said shift catalyst bed are disposed within said chamber.

129. The integrated reactor of claim 128, wherein said mixed oxide bed comprises a pelletized metal oxide bed.

130. The integrated reactor of claim 128, wherein said metal oxide bed comprises a metal oxide monolith.

131. The integrated reactor of claim 128, wherein said metal oxide bed is selected from the group consisting of pelletized zinc oxide beds and zinc oxide monoliths.

132. The integrated reactor of claim 128, wherein said shift catalyst bed comprises a pelletized shift catalyst composition.

133. The integrated reactor of claim 128, wherein said shift catalyst bed comprises a shift catalyst monolith.

134. The integrated reactor of claim 128, further comprising a reduced base metal absorbent bed interposed between and in fluid communication with said metal oxide bed and said shift catalyst bed.

135. The integrated reactor of claim 134 wherein said reduced base metal absorbent bed comprises a copper-zinc compound.

136. The integrated reactor of claim 128, further comprising a high-temperature shift catalyst bed disposed between and in fluid communication with said reformate inlet and said metal oxide bed.

137. The integrated reactor of claim 134, further comprising a high-temperature shift catalyst bed disposed between and in fluid communication with said reformate inlet and said metal oxide bed.

138. The integrated reactor of claim 128, wherein said at least one heat exchange element comprises a passage extending through at least a portion of said chamber.

139. The integrated reactor of claim 128, wherein said at least one heat exchange element comprises a plurality of passages extending through at least a portion of said chamber.

140. The integrated reactor of claim 128, wherein said at least one heat exchange element further comprises the exterior surface of said chamber.

141. A fuel processing system for converting a fuel into a reformate stream, said fuel processing system comprising a reformer and an integrated reactor comprising:
a closed vessel having a reformate inlet and a reformate outlet for receiving and discharging, respectively, a reformate stream, and having a coolant inlet and a coolant outlet for receiving and discharging, respectively, a coolant fluid stream;
a metal oxide bed disposed within said vessel and in fluid communication with said reformate inlet;
a shift catalyst bed disposed within said vessel downstream of said metal oxide bed, said shift catalyst bed in fluid communication with said metal oxide bed and said reformate outlet; and
at least one heat exchange element in fluid communication with said coolant inlet and said coolant outlet, and in thermal communication with said metal oxide bed and said shift catalyst bed, said at least one heat exchange element fluidly isolated from said metal oxide bed and said shift catalyst bed,
wherein said integrated reactor is located downstream of said reformer and fluidly connected thereto.

142. A fuel processing system for converting a fuel into a reformate stream, said fuel processing system comprising a reformer and an integrated reactor comprising:
a closed vessel having a reformate inlet and a reformate outlet for receiving and discharging, respectively, a reformate stream, and having a coolant inlet and a coolant outlet for receiving and discharging, respectively, a coolant fluid stream;
a metal oxide bed disposed within said vessel and in fluid communication with said reformate inlet;
a shift catalyst bed disposed within said vessel downstream of said metal oxide bed, said shift catalyst bed in fluid communication with said metal oxide bed and said reformate outlet;
at least one heat exchange element in fluid communication with said coolant inlet and said coolant outlet, and in thermal communication with said metal oxide bed and said shift catalyst bed, said at least one heat exchange element fluidly isolated from said metal oxide bed and said shift catalyst bed; and
a chamber disposed within said vessel, said chamber in fluid communication with said reformate inlet and said reformate outlet, and wherein said metal oxide bed and said shift catalyst bed are disposed within said chamber,
wherein said integrated reactor is located downstream of said reformer and fluidly connected thereto.
